(19) United States
(12) Patent Application Publication
(10) Pub. No.: US 2025/0055585 A1
(43) Pub. Date: Feb. 13, 2025

(54) PHASE CONTINUITY CONFIGURATION IN CROSS-LINK INTERFERENCE (CLI) BASED SENSING

(71) Applicant: QUALCOMM Incorporated, San Diego, CA (US)

(72) Inventors: Yuwei REN, Beijing (CN); Weimin DUAN, San Diego, CA (US); Huilin XU, Temecula, CA (US)

(21) Appl. No.: 18/718,426

(22) PCT Filed: Feb. 16, 2022
(86) PCT No.: PCT/CN2022/076410

§ 371 Date: Jun. 10, 2024

(51) Int. Cl. H04B 17/309; H04L 5/00; H04W 24/10

(52) U.S. Cl. CPC H04B 17/346; H04L 5/0051; H04W 24/10

(57) ABSTRACT

Disclosed are systems and techniques for providing a phase continuity configuration in cross-link interference (CLI) based sensing. For instance, a method for wireless communications at a user equipment (UE) may include receiving, at the UE, a phase reporting configuration from a network entity. The method may include generating, at the UE based on the phase reporting configuration, a phase report comprising one or more phase measurements of a cross-link interference (CLI)-based sensing resource. The method may further include transmitting, to the network entity, the phase report comprising the one or more phase measurements of the CLI-based sensing resource.

### CROSS-REFERENCE TO RELATED APPLICATIONS

This application for Patent is a 371 of international Patent Application PCT/CN2022/076410, filed Feb. 16, 2022, which is hereby incorporated by reference in its entirety and for all purposes.

### FIELD OF THE DISCLOSURE

The present disclosure generally relates to cross-link interference (CLI) based sensing. For example, aspects of the disclosure relate to systems and techniques for providing a phase continuity configuration in CLI-based sensing.

### BACKGROUND OF THE DISCLOSURE

Wireless communications systems are widely deployed to provide various types of communication content, such as voice, video, packet data, messaging, and broadcast. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Some wireless communications systems may support communications between UEs, which may involve direct transmissions between two or more UEs.

Radar sensing systems typically use RF waveforms to estimate characteristics (e.g., presence, distance, angle, movement, and/or velocity) of a target object, such as a user or other object. The phase variation pattern of the RF waveforms may be used to identify characteristics that may be related to vital signs of a user, such as chest movement, which may indicate the breathing or heart beating of a user. However, during operation of the radar system, phase jumping may occur within an RF waveform. This phase jumping can destroy the phase variation pattern of the RF waveform, thereby making it difficult to determine the user's vital signs.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for providing a phase continuity configuration in CLI-based sensing. According to at least one example, a method is provided for wireless communications at a user equipment (UE). The method includes: receiving, at the UE, a phase reporting configuration from a network entity; generating, at the UE based on the phase reporting configuration, a phase report comprising one or more phase measurements of a cross-link interference (CLI)-based sensing resource; and transmitting, to the network entity, the phase report comprising the one or more phase measurements of the CLI-based sensing resource.

In another example, an apparatus (e.g., a user equipment (UE) or other device) for wireless communications is provided that includes a memory (e.g., configured to store data, such as virtual content data, one or more images, etc.) and one or more processors (e.g., implemented in circuitry) coupled to the memory. The one or more processors are configured to and can: receive a phase reporting configuration from a network entity; generate, based on the phase reporting configuration, a phase report comprising one or more phase measurements of a cross-link interference (CLI)-based sensing resource; and transmit, to the network entity, the phase report comprising the one or more phase measurements of the CLI-based sensing resource.

In another example, a non-transitory computer-readable medium of a user equipment (UE) is provided that has stored thereon instructions that, when executed by one or more processors, cause the one or more processors to: receive a phase reporting configuration from a network entity; generate, based on the phase reporting configuration, a phase report comprising one or more phase measurements of a cross-link interference (CLI)-based sensing resource; and transmit, to the network entity, the phase report comprising the one or more phase measurements of the CLI-based sensing resource.

In another example, an apparatus (e.g., a UE or other device) for wireless communications is provided. The apparatus includes: means for receiving a phase reporting configuration from a network entity; means for generating, at the UE based on the phase reporting configuration, a phase report comprising one or more phase measurements of a cross-link interference (CLI)-based sensing resource; and means for transmitting, to the network entity, the phase report comprising the one or more phase measurements of the CLI-based sensing resource.

According to at least one other example, a method is provided for wireless communications at a network entity. The method includes: transmitting, to a UE, a phase reporting configuration; and receiving, at the network entity from the UE based on the phase reporting configuration, a phase report comprising one or more phase measurements of a cross-link interference (CLI)-based sensing resource.

In another example, an apparatus (e.g., a network entity) for wireless communications at a network entity is provided that includes a memory (e.g., configured to store data, such as virtual content data, one or more images, etc.) and one or more processors (e.g., implemented in circuitry) coupled to the memory. The one or more processors are configured to and can: transmit, to a UE, a phase reporting configuration; and receive, from the UE based on the phase reporting configuration, a phase report comprising one or more phase measurements of a cross-link interference (CLI)-based sensing resource.

In another example, a non-transitory computer-readable medium of a network entity is provided that has stored thereon instructions that, when executed by one or more processors, cause the one or more processors to: transmit, to a UE, a phase reporting configuration; and receive, from the UE based on the phase reporting configuration, a phase report comprising one or more phase measurements of a cross-link interference (CLI)-based sensing resource.

In another example, an apparatus (e.g., a network entity) for wireless communications at a network entity is provided. The apparatus includes: means for transmitting, to a UE, a phase reporting configuration; and means for receiving, from the UE based on the phase reporting configuration, a phase report comprising one or more phase measurements of a cross-link interference (CLI)-based sensing resource.

In some aspects, the apparatus is, or is part of, a mobile device (e.g., a mobile telephone or so-called “smart phone” or other mobile device), a wearable device, an extended reality (XR) device (e.g., a virtual reality (VR) device, an augmented reality (AR) device, or a mixed reality (MR) device), a personal computer, a laptop computer, a tablet computer, an Internet-of-Things (IoT) device, a wireless access point, a vehicle or component of a vehicle, a server computer, a robotics device, or other device. In some aspects, the apparatus includes radio detection and ranging (radar) for capturing radio frequency (RF) signals. In some aspects, the apparatus includes light detection and ranging (LIDAR) for capturing optical frequency signals. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors, which can be used for determining a location of the apparatuses, a state of the apparatuses (e.g., a temperature, a humidity level, and/or other state), and/or for other purposes.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network that may be employed by the disclosed systems and techniques for a phase continuity configuration in CLI-based sensing, in accordance with some examples.

FIG. 2 is a diagram illustrating a design of a base station and a user equipment (UE) device that enable transmission and processing of signals exchanged between the UE and the base station, which may be employed by the disclosed systems and techniques for a phase continuity configuration in CLI-based sensing, in accordance with some examples.

FIG. 3 is a diagram illustrating an example of a disaggregated base station architecture, which may be employed by the disclosed systems and techniques for a phase continuity configuration in CLI-based sensing, in accordance with some examples.

FIG. 4 is a diagram illustrating an example of a frame structure, which may be employed by the disclosed systems and techniques for a phase continuity configuration in CLI-based sensing, in accordance with some examples.

FIG. 5 is a diagram illustrating an example of a slot format table, which may be employed by the disclosed systems and techniques for a phase continuity configuration in CLI-based sensing, in accordance with some examples.

FIG. 6 is a block diagram illustrating an example of a computing system of an electronic device that may be employed by the disclosed systems and techniques for a phase continuity configuration in CLI-based sensing, in accordance with some examples.

FIG. 7 is a diagram illustrating an example of a wireless device utilizing RF monostatic sensing techniques, which may be employed by the disclosed systems and techniques for a phase continuity configuration in CLI-based sensing, to determine one or more characteristics of a target object, in accordance with some examples.

FIG. 8 is a diagram illustrating an example geometry for sensing (e.g., monostatic or bistatic sensing), in accordance with some examples.

FIG. 9 is a diagram illustrating an example frame structure with TDD multiplexing, which may be employed by the disclosed systems and techniques for a phase continuity configuration in CLI-based sensing, in accordance with some examples.

FIG. 10 is a diagram illustrating an example of obtaining micro-Doppler measurements, which may be performed by the disclosed systems and techniques for a phase continuity configuration in CLI-based sensing, in accordance with some examples.

FIG. 11 is a graph illustrating an example phase variation pattern of breathing by a user obtained from micro-Doppler measurements, in accordance with some examples.

FIG. 12 is a diagram depicting an example of the occurrence of CLI in a system, in accordance with some examples.

FIG. 13 is a diagram illustrating an example TDD configurations for the system of FIG. 12, in accordance with some examples.

FIG. 14 is a diagram depicting an example of sidelink-based sensing in a system, in accordance with some examples.

FIG. 15 is a diagram depicting an example of CLI-based sensing in a system, in accordance with some examples.

FIG. 16 is a diagram illustrating an example frame structure with TDD multiplexing that is exhibiting phase jumping, in accordance with some examples.

FIG. 17 includes two graphs, where one graph depicts an example phase pattern with phase continuity and another graph depicts an example pattern with phase jumping, in accordance with some examples.

FIG. 18 is a diagram illustrating the disclosed system for a phase continuity configuration in CLI-based sensing, in accordance with some examples.

FIG. 19 is a diagram of an example communication exchange for phase reporting for the system of FIG. 18, in accordance with some examples.

FIG. 20 is a diagram illustrating an example frame structure with TDD multiplexing showing an SRS occasion, which may be employed by the disclosed systems and techniques for a phase continuity configuration in CLI-based sensing, in accordance with some examples.

FIG. 21 is a diagram illustrating an example frame structure 2100 with TDD multiplexing showing a phase measurement duration, which may be employed by the disclosed systems and techniques for a phase continuity configuration in CLI-based sensing, in accordance with some examples.

FIG. 22 is a flow chart illustrating an example of a process for wireless communications at a user equipment (UE), in accordance with some examples.

FIG. 23 is a flow chart illustrating an example of a process for wireless communications at a network entity, in accordance with some examples.

FIG. 24 is a block diagram illustrating an example of a computing system that may be employed by the disclosed system for a phase continuity configuration in CLI-based sensing, in accordance with some examples.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

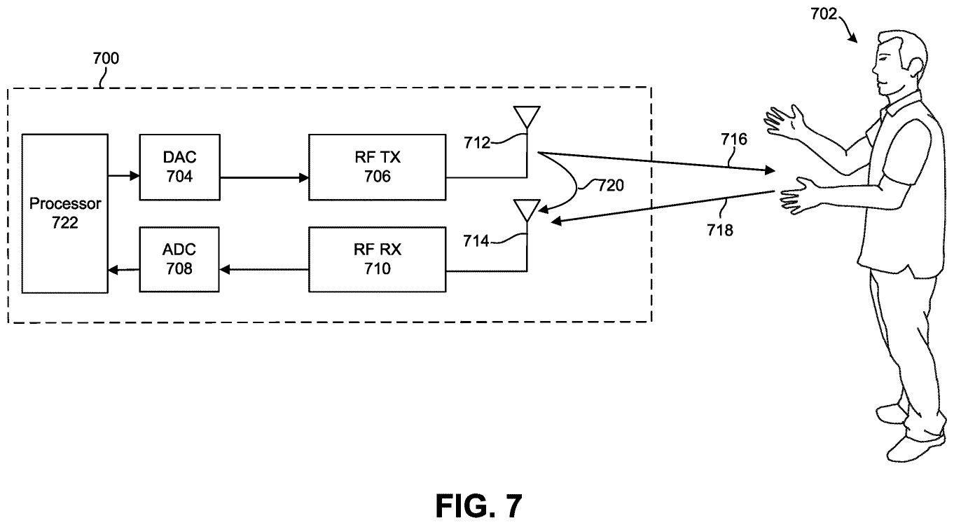

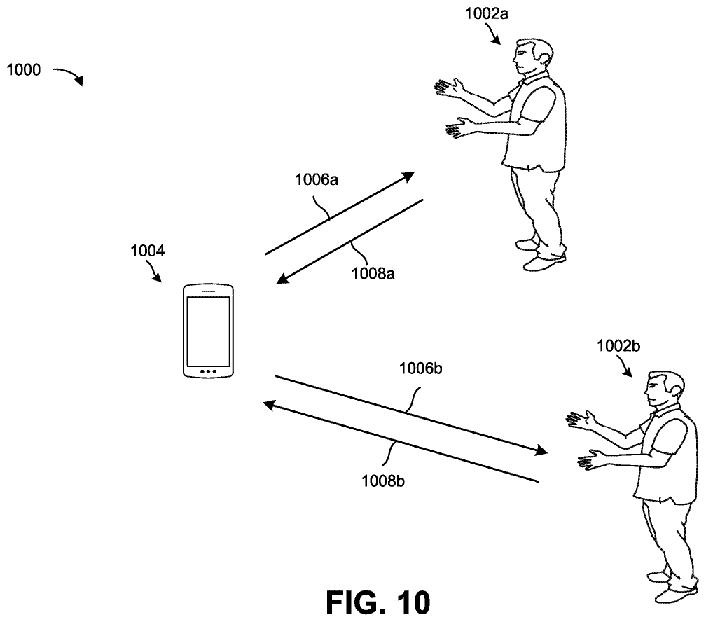

Radar sensing systems typically use RF waveforms to perform RF sensing to estimate characteristics (e.g., presence, distance, angle, movement, and/or velocity) of a target object, such as a user or other object. In some cases, the characteristics may be related to vital signs of a user, such as chest movement, which may indicate the breathing or heart beating of a user. A typical radar system includes at least one transmitter, at least one receiver, and at least one processor. A radar sensing system may perform monostatic sensing when one receiver is employed that is co-located with a transmitter, as is shown in FIGS. 7 and 10. A radar system may perform bistatic sensing when one receiver of a first device is employed that is located remote from a transmitter of a second device. Similarly, a radar system may perform multi-static sensing when multiple receivers of multiple devices are employed that are all located remotely from at least one transmitter of at least one device.

During operation of a radar sensing system, a transmitter transmits an electromagnetic (EM) signal in the RF domain towards a target object. The signal reflects off of the target object to produce one or more reflection signals, which provides information or properties regarding the target, such as target object's location and movement. At least one receiver receives the one or more reflection signals and at least one processor, which may be associated with at least one receiver, utilizes the information from the one or more reflection signals to determine information or properties of the target object. A target object can also be referred herein as a target, and these radar sensing signals can be referred to as radar reference signals (RSs).

As previously mentioned, in radar sensing, the phase variation pattern of the RF waveforms may be used to identify characteristics that may be related to vital signs of a user, such as chest movement, which may indicate the breathing or heart beating of a user. However, during operation of the radar system, phase jumping may occur within an RF waveform. This phase jumping can destroy the phase variation pattern of the RF waveform, thereby making it difficult to determine the user's vital signs.

A wireless multiple-access communications system may employ time division duplexing (TDD) for communications and/or sensing. In some cases, neighboring cells within the system may have different TDD configurations that may cause an overlap in conflicting transmissions. For example, an uplink transmission by a first UE may interfere (overlap) with a downlink reception by a second UE if the uplink transmission and the downlink reception are scheduled to use the same frequency at the same time. This type of interference between UEs utilizing TDD is referred to as cross-link interference (CLI).

Systems, apparatuses, processes (also referred to as methods), and computer-readable media (collectively referred to herein as systems and techniques) are described herein that employ CLI-based sensing to monitor and report the phase continuity (e.g., phase jumping) of RF waveforms (e.g., a CLI sensing resource) that are used to detect characteristics of a target object, such as a user. The disclosed system can also apply an appropriate phase compensation to restore the phase continuity to eliminate the phase jumping within the RF waveforms. Additional details regarding the disclosed systems and methods for providing a phase continuity configuration in CLI-based sensing, as well as specific implementations, are described below.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity.” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

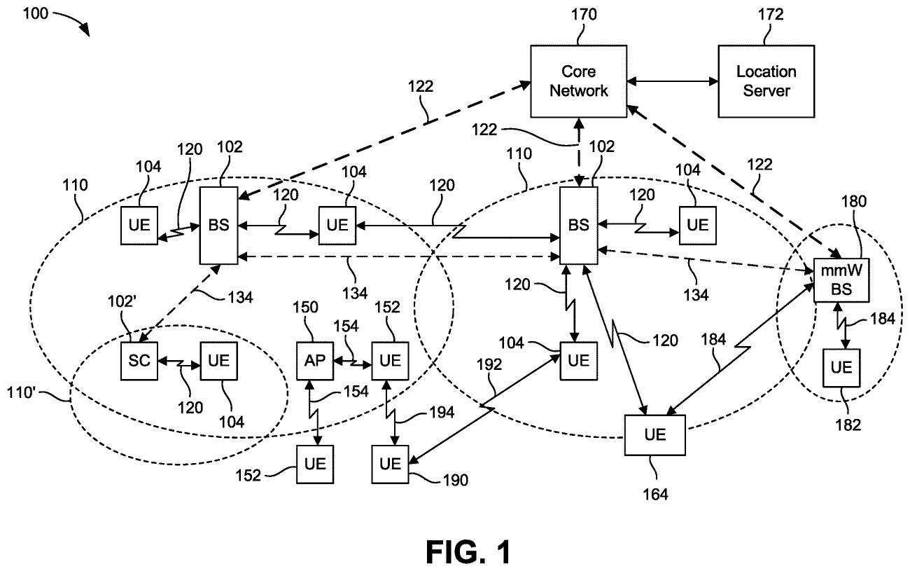

FIG. 1 illustrates an example of a wireless communications system 100 that may be employed by the disclosed systems and techniques for a phase continuity configuration in CLI-based sensing, according to various aspects. The wireless communications system 100 (which may also be referred to as a wireless wide area network (WWAN)) may include various base stations 102 and various user equipment devices (UEs) 104. As used herein, the term “UE” may be referred to interchangeably as an “access terminal” or “AT,” a “user device,” a “user terminal” or UT, a “client device,” a “wireless device,” a “subscriber device,” a “subscriber terminal,” a “subscriber station,” a “mobile device,” a “mobile terminal,” a “mobile station,” or variations thereof.

The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a 4G/LTE network, or gNBs where the wireless communications system 100 corresponds to a 5G/NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 (e.g., access links) between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs etc.) that communicate with one or more UEs 104, base stations 102, APs 150, etc. utilizing the ultra-wideband (UWB) spectrum. The UWB spectrum can range from 3.1 to 10.5 GHZ.

The small cell base station 102′ may operate in a licensed and/or an unlicensed frequency spectrum (e.g., utilizing LTE or NR technology and use the same 5 GHZ unlicensed frequency spectrum as used by the WLAN AP 150). The wireless communications system 100 may further include a millimeter wave (mmW) base station 180 that may operate in mmW frequencies and/or near mmW frequencies in communication with a UE 182. In some cases, mmW frequencies can be referred to as the FR2 band (e.g., including a frequency range of 24250 MHz to 52600 MHZ). In some examples, the wireless communications system 100 can include one or more base stations (referred to herein as “hybrid base stations”) that operate in both the mmW frequencies (and/or near mmW frequencies) and in sub-6 GHz frequencies (referred to as the FR1 band, e.g., including a frequency range of 450 to 6000 MHz). In some examples, the mmW base station 180, one or more hybrid base stations (not shown), and the UE 182 may utilize beamforming (transmit and/or receive) over a mmW communication link 184 to compensate for the extremely high path loss and short range. The wireless communications system 100 may further include a UE 164 that may communicate with a macro cell base station 102 over a communication link 120 and/or the mmW base station 180 over a mmW communication link 184.

In some examples, in order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that can be tuned to band (i.e., carrier frequency) ‘X’ or band ‘Y,’ and “Receiver 2” is a one-band receiver tuneable to band ‘Z’ only.

The wireless communications system 100 may further include one or more UEs, such as UE 190, that connect indirectly to one or more communication networks via one or more relay devices (e.g., UEs) by using device-to-device (D2D) peer-to-peer (P2P) links (referred to as “sidelinks”). In the example of FIG. 1, UE 190 has a D2D P2P link 192 with one of the UEs 104, which can be configured to operate as a relay device (e.g., through which UE 190 may indirectly communicate with base station 102). In another example, UE 190 also has a D2D P2P link 194 with WLAN STA 152, which is connected to the WLAN AP 150 and can be configured to operate as a relay device (e.g., UE 190 may indirectly communicate with AP 150). In an example, the D2D P2P links 192 and 194 may be supported with any well-known D2D RAT, such as LTE Direct (LTE-D), Wi-Fi Direct (Wi-Fi-D), Bluetooth®, UWB, and so on.

As noted above, UE 104 and UE 190 can be configured to communicate using sidelink communications. In some examples, UE 104 and UE 190 can operate using one or more different modes for sidelink communications. For example, in mode 1 the cellular network (e.g., base station 102) can select and manage the radio resources used by the UEs for performing sidelink communications. In another example, the UE 104 and UE 190 can be configured to operate using mode 2 in which the UEs can autonomously select the radio resources for sidelink communications. Mode 2 can operate without cellular coverage, and in some cases can be considered a baseline sidelink communications mode as devices and/or applications may not depend on the availability of cellular coverage. In some examples, mode 2 can include a distributed scheduling scheme for UEs to select radio resources.

In some aspects, UE 104 and UE 190 can be configured to implement a multi-beam unicast link for sidelink communications. In some examples, UE 104 and UE 190 can use PC5 radio resource control (RRC) protocol to establish and maintain a multi-beam unicast link that can be used for sidelink communications. In some cases, a sidelink transmission can include a request for feedback (e.g., a hybrid automatic repeat request (HARQ)) from the receiving UE. In some instances, the feedback request can be included in the sidelink control information (SCI) (e.g., SCI 1 in Physical Sidelink Control Channel (PSCCH) and/or SCI 2 in Physical Sidelink Shared Channel (PSSCH)). In some aspects, the feedback can correspond to an acknowledgement (ACK) or a negative acknowledgement (NACK).

In some examples, a transmitting UE (e.g., UE 104 and/or UE 190) can use feedback information to select and/or perform beam maintenance of beam pairs associated with a unicast link for sidelink communications. For example, a transmitting UE can maintain one or more counters associated with one or more beam pairs and/or one or more component beams. In some aspects, the counters can be used to determine the reliability of a component beam and/or a beam pair. In some cases, a transmitting UE may increment a counter for a beam pair and/or a component beam based on a discontinuous transmission (DTX). For example, a transmitting UE may increment a counter for a component beam and/or a beam pair if it does not receive any response to a request for feedback for an associated sidelink transmission (e.g., receiving UE fails to decode SCI).

In another example, a transmitting UE may increment a counter for a component beam and/or a beam pair if it receives a NACK in response to a sidelink transmission.

In some cases, a transmitting UE may initiate beam refinement based on a value of a counter corresponding to a number of DTXs associated with a component beam and/or a beam pair. In some aspects, a transmitting UE may initiate beam recovery based on a value of a counter corresponding to a number of DTXs associated with a component beam and/or a beam pair. In some examples, a transmitting UE may detect radio link failure (RLF) based on a value of a counter corresponding to a number of DTXs associated with a component beam and/or a beam pair.

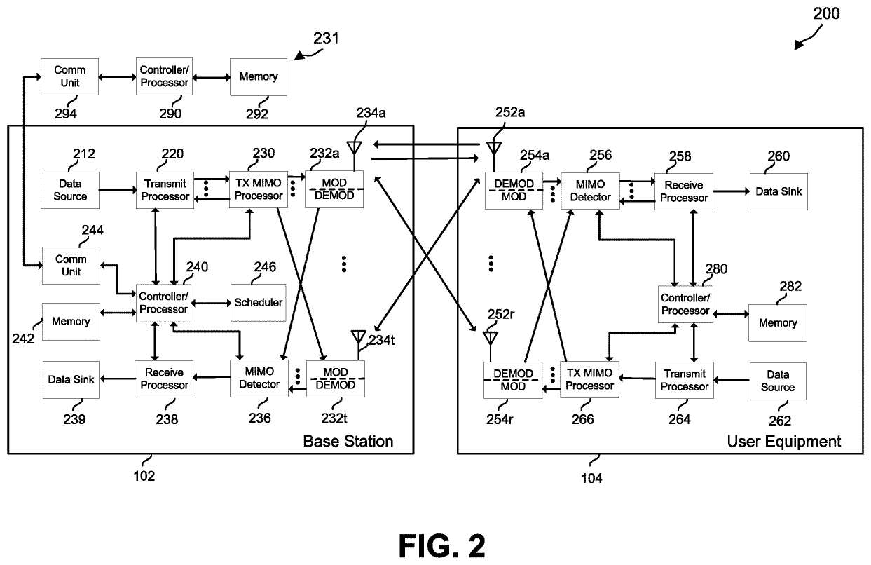

FIG. 2 shows a block diagram of a design of a base station 102 and a UE 104 that enable transmission and processing of signals exchanged between the UE and the base station, which may be employed by the disclosed systems and techniques for a phase continuity configuration in CLI-based sensing, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 2321, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with providing a phase continuity configuration in CLI-based sensing.

Memories 242 and 282 may store data and program codes for the base station 102 and the UE 104, respectively. A scheduler 246 may schedule UEs for data transmission on the downlink, uplink, and/or sidelink.

In some implementations, the UE 104 can include: means for receiving a phase reporting configuration from a network entity; means for generating, at the UE based on the phase reporting configuration, a phase report comprising one or more phase measurements of a cross-link interference (CLI)-based sensing resource; and means for transmitting, to the network entity, the phase report comprising the one or more phase measurements of the CLI-based sensing resource. In some examples, the means for receiving can include controller/processor 280, transmit processor 264, TX MIMO processor 266, DEMODs 254a through 254r, antennas 252a through 252r, any combination thereof, or any other component(s) of the UE 104. In some examples, the means for generating can include controller/processor 280, memory 282, receive processor 258, transmit processor 264, any combination thereof, or any other component(s) of the UE 104. In some examples, the means for transmitting can include controller/processor 280, transmit processor 264, TX MIMO processor 266, MODs 254a through 254r, antennas 252a through 252r, any combination thereof, or any other component(s) of the UE 104.

In some implementations, the base station 102 can include: means for transmitting, to a UE, a phase reporting configuration; and means for receiving, from the UE based on the phase reporting configuration, a phase report comprising one or more phase measurements of a cross-link interference (CLI)-based sensing resource. In some examples, the means for transmitting can include controller/processor 240, transmit processor 220, TX MIMO processor 230, MODs 234a through 2341, antennas 234a through 234t, any combination thereof, or any other component(s) of the base station 102. In some examples, the means for receiving can include controller/processor 240, transmit processor 220, TX MIMO processor 230, DEMODs 234a through 234t, antennas 234a through 234t, any combination thereof, or any other component(s) of the base station 102.

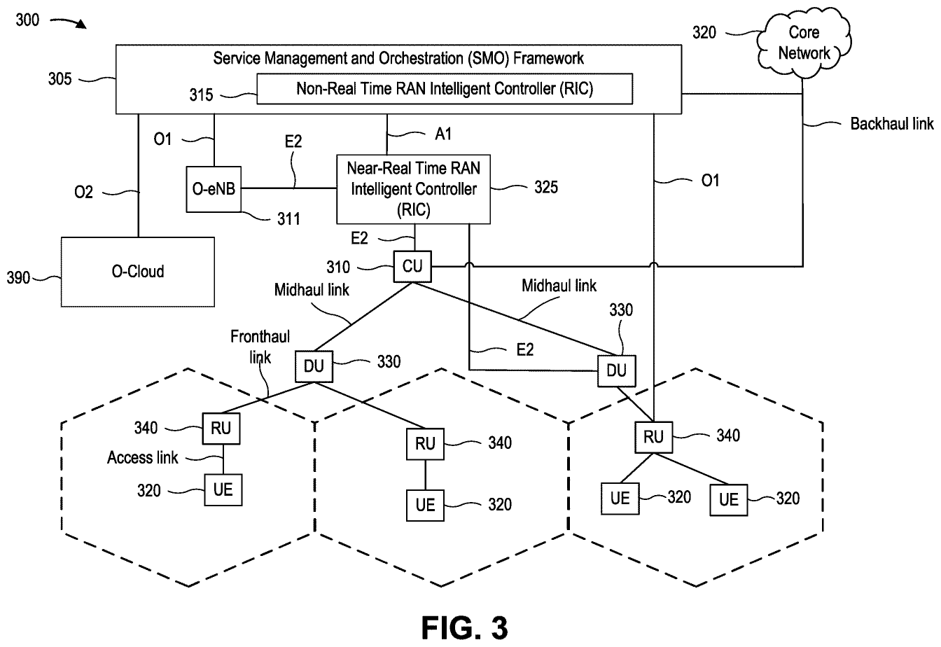

FIG. 3 is a diagram illustrating an example of a disaggregated base station 300 architecture, which may be employed by the disclosed systems and techniques for a phase continuity configuration in CLI-based sensing, in accordance with some examples. Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, AP, a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

As previously mentioned, FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 320 via one or more RF access links. In some implementations, the UE 320 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 320. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

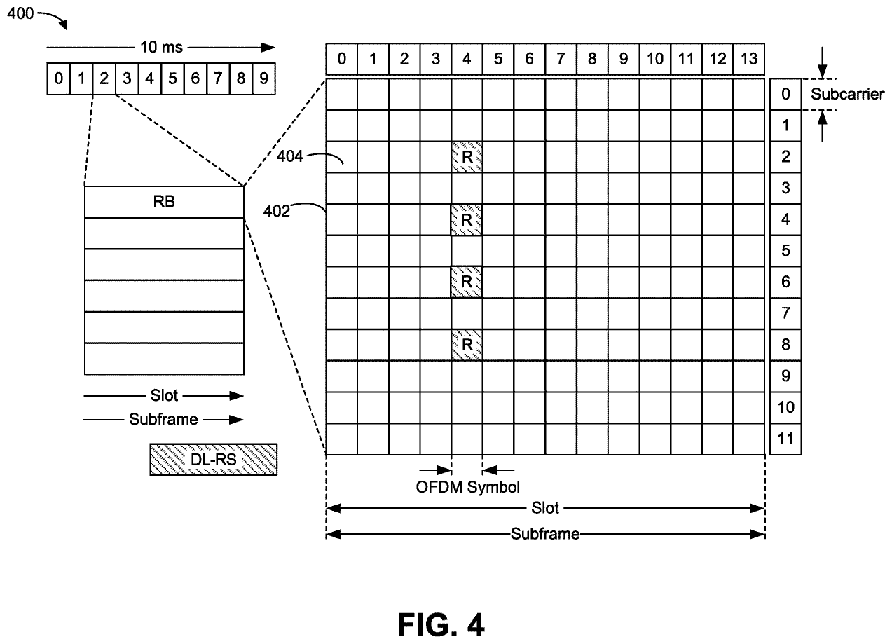

Various radio frame structures may be used to support downlink, uplink, and sidelink transmissions between network nodes (e.g., base stations and UEs). FIG. 4 is a diagram 400 illustrating an example of a frame structure, which may be employed by the disclosed systems and techniques for a phase continuity configuration in CLI-based sensing (e.g., for signaling for communications and/or sensing purposes), according to some aspects of the disclosure. Other wireless communications technologies may have different frame structures and/or different channels.

NR (and LTE) utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing, symbol length, etc.). In contrast, NR may support multiple numerologies (u). For example, subcarrier spacing (SCS) of 15 KHz, 30 kHz, 60 kHz, 120 kHz, and 240 kHz or greater may be available. Table 1 provided below lists some various parameters for different NR numerologies.

TABLE 1

| | | | | | | | Max. nominal |
|---|---|---|---|---|---|---|---|
| | | | | | Slot | Symbol | system BW |
| | SCS | Symbols/ | Slots/ | Slots/ | Duration | Duration | (MHz) with |
| | (kHz) | Sot | Subframe | Frame | (ms) | (μs) | 4K FFT size |
| 0 | 15 | 14 | 1 | 10 | 1 | 66.7 | 50 |
| 1 | 30 | 14 | 2 | 20 | 0.5 | 33.3 | 100 |
| 2 | 60 | 14 | 4 | 40 | 0.25 | 16.7 | 100 |
| 3 | 120 | 14 | 8 | 80 | 0.125 | 8.33 | 400 |
| 4 | 240 | 14 | 16 | 160 | 0.0625 | 4.17 | 800 |

In one example, a numerology of 15 kHz is used. Thus, in the time domain, a 10 millisecond (ms) frame is divided into 10 equally sized subframes of 1 ms each, and each subframe includes one time slot. In FIG. 4, time is represented horizontally (e.g., on the X axis) with time increasing from left to right, while frequency is represented vertically (e.g., on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. FIG. 4 illustrates an example of a resource block (RB) 402. The resource grid is further divided into multiple resource elements (REs). Referring to FIG. 4, the RB 402 includes multiple REs, including the resource element (RE) 404. The RE 404 may correspond to one symbol length in the time domain and one subcarrier in the frequency domain. In the numerology of FIG. 4, for a normal cyclic prefix, RB 402 may contain 12 consecutive subcarriers in the frequency domain and seven consecutive symbols in the time domain, for a total of 84 REs such as RE 404. For an extended cyclic prefix, an RB may contain 12 consecutive subcarriers in the frequency domain and six consecutive symbols in the time domain, for a total of 72 REs. The number of bits carried by each RE depends on the modulation scheme.

In some aspects, some REs can be used to transmit downlink reference (pilot) signals (DL-RS). The DL-RS can include Positioning Reference Signal (PRS), Tracking Reference Signal (TRS), Phase Tracking Reference Signal (PTRS), Channel State Information Reference Signal (CSI-RS), Demodulation Reference Signal (DMRS), Primary Synchronization Signal (PSS), Secondary Synchronization Signal (SSS), etc. The resource grid if FIG. 4 illustrates exemplary locations of REs used to transmit DL-RS (labeled “R”).

In some aspects, one or more resources in the resource grid can be used to perform sidelink communications. For example, sidelink communications can be implemented using a mode (e.g., mode 1) in which a base station (e.g., base station 102 of FIG. 1) can designate/select one or more resources (e.g., resource elements (e.g., RE 404), resource blocks (e.g., RB 402), subcarriers, symbols, frames, sub-frames, etc.) for sidelink communications. In another example, sidelink communications can be implemented using a mode (e.g., mode 2) in which a UE (e.g., UE 104 of FIG. 1) can designate/select one or more resources (e.g., resource elements (e.g., RE 404), resource blocks (e.g., RB 402), subcarriers, symbols, frames, sub-frames, etc.) for sidelink communications. In some aspects, resource allocation for sidelink communications can correspond to one or more subchannels in the frequency domain and one or more slots in the time domain. In some cases, a subchannel may include from 10 RBs to 100 RBs. In some examples, a sidelink slot may include 7-14 OFDM symbols.

In some examples, a UE (e.g., UE 104 of FIG. 1) can be configured to receive a sidelink packet by performing blind decoding of all sidelink subchannels. In some aspects, the sidelink UE can decode a Physical Sidelink Control Channel (PSCCH) in a configured sidelink resource pool. In some cases, the PSCCH can be used to carry sidelink control information (SCI) which contains information about the resource allocation on the Physical Sidelink Shared Channel (PSSCH). For example, a first stage SCI can be transmitted in PSCCH and may include information regarding the PSSCH bandwidth as well as resource reservations in future slots. In some cases, a second stage SCI can be located and decoded after decoding PSCCH. In some aspects, a source identifier and/or a destination identifier can be used to determine a source and/or destination UE associated with a packet. In some examples, the UE can proceed with decoding PSSCH if PSCCH (e.g., SCI) indicates a receiver ID matching the UE's ID. In some configurations, PSCCH and PSSCH can be transmitted using the same slot.

In some examples, PSCCH may be configured to occupy or use multiple RBs in a single subchannel. In some aspects, a subchannel can occupy multiple PRBs (e.g., a subchannel can occupy 10, 15, 20, 25, 50, 75, 100 PRBs). In some cases, PSCCH may be configured to occupy 10, 12, 15, 20, or 25 PRBs in a subchannel. In some aspects, PSCCH may be limited to one subchannel. In some cases, the duration of PSCCH can be configured use 2 or 3 symbols. In some aspects, a resource pool (RP) can include any number of subchannels (e.g., a RP can include 1-27 subchannels). In some cases, the size of PSCCH may be fixed for a RP (e.g., size can correspond to 10% to 100% of a subchannel). In some examples, PSSCH may occupy 1 or more subchannels and may include a second stage SCI.

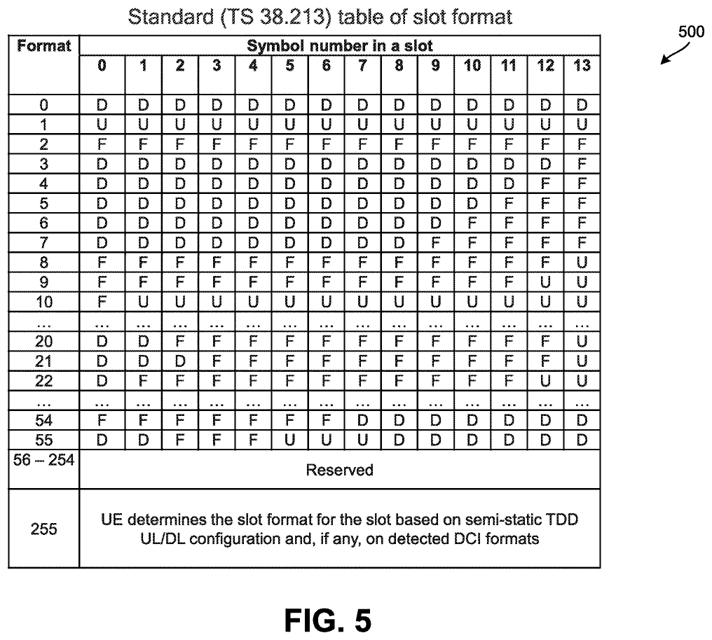

FIG. 5 is a diagram illustrating an example of a slot format table 500, which may be employed by the disclosed systems and techniques for a phase continuity configuration in CLI-based sensing, in accordance with some examples. In one or more examples, the slot format (e.g., as designated in a slot format table 500) may provide a network entity (e.g., a UE) with the required downlink and/or uplink transmission pattern. In some examples of the disclosed system, the slot format may provide the network entity an indication of an allocation of some of its resources (e.g., allocating RF sensing resources for communications purposes).

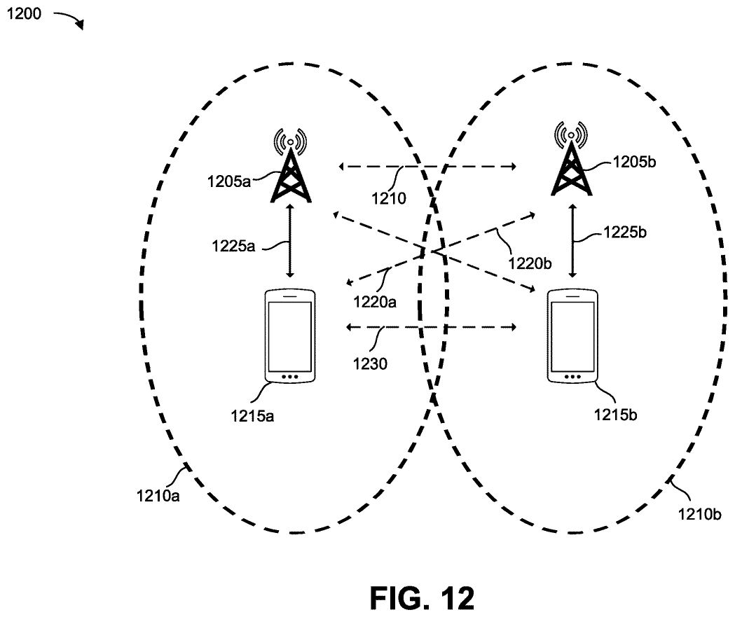

In one or more examples, a slot can be utilized as a dynamic scheduling unit (e.g., for communications and/or for RF sensing). The number of OFDM symbols per slot is typically fixed (e.g., as in NR). For example, when the cyclic prefixes (CPS) of an OFDM waveform have a normal duration, there are typically a total of fourteen OFDM symbols. In another example, when the CPs of an OFDM waveform have an extended duration, there are typically a total of twelve slots. The example slot format table 500 in FIG. 12 shows a total of fourteen OFDM symbols per slot.

In some cases, a slot may be classified as downlink, where all of the symbols of the slot are dedicated for the downlink transmissions. In some cases, a slot may be classified as uplink, where all of the symbols of the slot are dedicated for uplink transmissions. In the case of frequency division duplexing (FDD), all symbols within a slot for a downlink carrier are used for downlink transmissions, and all symbols within a slot for an uplink carrier are used for uplink transmissions.

However, in the case of time division duplexing (TDD) (e.g., as is shown in the slot format table 500 of FIG. 5), it is possible for a slot to be configured to be used for a mix of uplink and downlink transmissions. When using a mix of uplink and downlink transmissions for a slot, a guard period may be necessary for the transceiver switching from the downlink to the uplink, and to allow for a timing advance in the uplink.

NR TDD utilizes a flexible slot configuration (e.g., which is shown in the slot format table 500 of FIG. 5). For this configuration, OFDM symbols of a slot can be designated as “downlink” (e.g., represented by a “D” letter) for downlink transmissions, “uplink” (e.g., representing by a “U” letter) for uplink transmissions, or “flexible” (e.g., represented by an “F” letter). The flexible symbol “F” can be configured for either uplink or downlink transmissions. One of the intentions of introducing the flexible symbols within the slots is to handle the required guard period. It should be noted that if a slot format is not provided by the network (e.g., a network entity), all of the OFDM symbols are considered to be “flexible” as a default.

NR supports the slot format configuration in static, semi-static, or dynamic fashion. The static slot configuration and the semi-static slot configuration are executed using RRC, while the dynamic slot configuration is executed using physical downlink control channel (PDCCH) DCI. In TDD, for small and/or isolated cells, dynamic TDD may be more suitable to adapt to variations in traffic. For large cells, the semi-static TDD may be more suitable for handling interference issues.

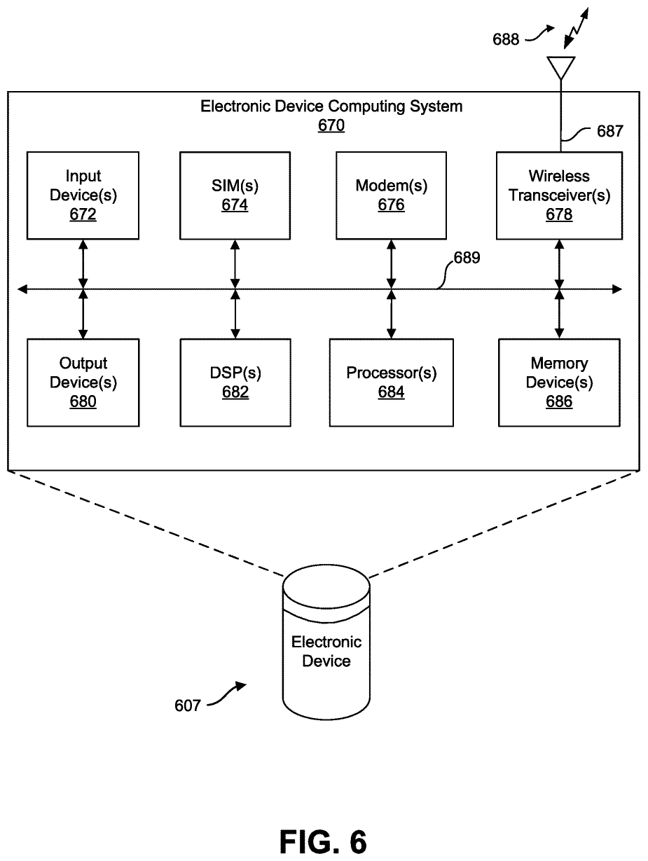

FIG. 6 is a block diagram illustrating an example of a computing system 670 of an electronic device 607 that may be employed by the disclosed systems and techniques for a phase continuity configuration in CLI-based sensing, in accordance with some examples. The electronic device 607 is an example of a device that can include hardware and software for the purpose of connecting and exchanging data with other devices and systems using a communications network (e.g., a 3GPP network, such as a 5G/NR network, a 4G/LTE network, a WiFi network, or other communications network). For example, the electronic device 607 can include, or be a part of, a mobile device (e.g., a mobile telephone), a wearable device (e.g., a network-connected or smart watch), an extended reality device (e.g., a VR device, an AR device, or a MR device), a personal computer, a laptop computer, a tablet computer, an IoT device, a wireless access point, a router, a vehicle or component of a vehicle, a server computer, a robotics device, and/or other device used by a user to communicate over a wireless communications network. In some cases, the device 607 can be referred to as UE, such as when referring to a device configured to communicate using 5G/NR, 4G/LTE, or other telecommunication standard. In some cases, the device can be referred to as a station (STA), such as when referring to a device configured to communicate using the Wi-Fi standard.

The computing system 670 includes software and hardware components that can be electrically or communicatively coupled via a bus 689 (or may otherwise be in communication, as appropriate). For example, the computing system 670 includes one or more processors 684. The one or more processors 684 can include one or more CPUs, ASICS, FPGAS, APs, GPUs, VPUs, NSPs, microcontrollers, dedicated hardware, any combination thereof, and/or other processing device/s and/or system/s. The bus 689 can be used by the one or more processors 684 to communicate between cores and/or with the one or more memory devices 686.

The computing system 670 may also include one or more memory devices 686, one or more digital signal processors (DSPs) 682, one or more subscriber identity modules (SIMs) 674, one or more modems 676, one or more wireless transceivers 678, one or more antennas 687, one or more input devices 672 (e.g., a camera, a mouse, a keyboard, a touch sensitive screen, a touch pad, a keypad, a microphone or a microphone array, and/or the like), and one or more output devices 680 (e.g., a display, a speaker, a printer, and/or the like).

The one or more wireless transceivers 678 can receive wireless signals (e.g., signal 688) via antenna 687 from one or more other devices, such as other user devices, network devices (e.g., base stations such as evolved Node Bs (eNBs) and/or gNodeBs (gNBs), WiFi access points (APs) such as routers, range extenders or the like, etc.), cloud networks, and/or the like. In some examples, the computing system 670 can include multiple antennas or an antenna array that can facilitate simultaneous transmit and receive functionality. Antenna 687 can be an omnidirectional antenna such that RF signals can be received from and transmitted in all directions. The wireless signal 688 may be transmitted via a wireless network. The wireless network may be any wireless network, such as a cellular or telecommunications network (e.g., 3G, 4G, 5G, etc.), wireless local area network (e.g., a WiFi network), a Bluetooth™ network, and/or other network. In some examples, the one or more wireless transceivers 678 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals 688 into a baseband or intermediate frequency and can convert the RF signals to the digital domain.

In some cases, the computing system 670 can include a coding-decoding device (or CODEC) configured to encode and/or decode data transmitted and/or received using the one or more wireless transceivers 678. In some cases, the computing system 670 can include an encryption-decryption device or component configured to encrypt and/or decrypt data (e.g., according to the Advanced Encryption Standard (AES) and/or Data Encryption Standard (DES) standard) transmitted and/or received by the one or more wireless transceivers 678.

The one or more SIMs 674 can each securely store an international mobile subscriber identity (IMSI) number and related key assigned to the user of the electronic device 607. The IMSI and key can be used to identify and authenticate the subscriber when accessing a network provided by a network service provider or operator associated with the one or more SIMs 674. The one or more modems 676 can modulate one or more signals to encode information for transmission using the one or more wireless transceivers 678. The one or more modems 676 can also demodulate signals received by the one or more wireless transceivers 678 in order to decode the transmitted information. In some examples, the one or more modems 676 can include a WiFi modem, a 4G (or LTE) modem, a 5G (or NR) modem, and/or other types of modems. The one or more modems 676 and the one or more wireless transceivers 678 can be used for communicating data for the one or more SIMs 674.

The computing system 670 can also include (and/or be in communication with) one or more non-transitory machine-readable storage media or storage devices (e.g., one or more memory devices 686), which can include, without limitation, local and/or network accessible storage, a disk drive, a drive array, an optical storage device, a solid-state storage device such as a RAM and/or a ROM, which can be programmable, flash-updateable and/or the like. Such storage devices may be configured to implement any appropriate data storage, including without limitation, various file systems, database structures, and/or the like.

In various embodiments, functions may be stored as one or more computer-program products (e.g., instructions or code) in memory device(s) 686 and executed by the one or more processor(s) 684 and/or the one or more DSPs 682. The computing system 670 can also include software elements (e.g., located within the one or more memory devices 686), including, for example, an operating system, device drivers, executable libraries, and/or other code, such as one or more application programs, which may comprise computer programs implementing the functions provided by various embodiments, and/or may be designed to implement methods and/or configure systems, as described herein.

In some aspects, the electronic device 607 can include means for performing operations described herein. The means can include one or more of the components of the computing system 670. For example, the means for performing operations described herein may include one or more of input device(s) 672, SIM(s) 674, modems(s) 676, wireless transceiver(s) 678, output device(s) 680, DSP(s) 682, processors 684, memory device(s) 686, and/or antenna(s) 687.

In some aspects, the electronic device 607 can include means for determining or scheduling sensing nodes for sensing a target object (also referred to as a target), means for using the determined or scheduled sensing nodes to obtain sensing measurements associated with the target, and/or means for determining a location of the target by using the sensing measurements. In some examples, any or all of these means can include the one or more wireless transceivers 678, the one or more modems 676, the one or more processors 684, the one or more DSPs 682, the one or more memory devices 686, any combination thereof, or other component(s) of the electronic device 607.

FIG. 7 is a diagram illustrating an example of a wireless device 700 utilizing RF monostatic sensing techniques, which may be employed by the disclosed systems and techniques for a phase continuity configuration in CLI-based sensing, to determine one or more characteristics (e.g., presence, location, speed, velocity, heading, and/or movement, such as breathing) of a target 702 object (e.g., such as a user), in accordance with some examples. In particular, FIG. 7 is a diagram illustrating an example of a wireless device 700 (e.g., a transmit/receive sensing node) that utilizes RF sensing techniques (e.g., monostatic sensing) to perform one or more functions, such as detecting a presence, location, and/or movement of a target 702 (e.g., an object, user, or vehicle), which in this figure is illustrated in the form of a user (e.g., a person).

In some examples, the wireless device 700 can be a mobile phone, a tablet computer, a wearable device, a vehicle, an extending reality (XR) device, a computing device or component of a vehicle, or other device (e.g., device 607 of FIG. 6) that includes at least one RF interface. In some examples, the wireless device 700 can be a device that provides connectivity for a user device (e.g., for electronic device 607 of FIG. 6), such as a base station (e.g., a gNB, eNB, etc.), a wireless access point (AP), or other device that includes at least one RF interface.

In some aspects, wireless device 700 can include one or more components for transmitting an RF signal. The wireless device 700 can include at least one processor 722 for generating a digital signal or waveform. The wireless device 700 can also include a digital-to-analog converter (DAC) 704 that is capable of receiving the digital signal or waveform from the processor(s) 722 (e.g., a microprocessor), and converting the digital signal or waveform to an analog waveform. The analog signal that is the output of the DAC 704 can be provided to RF transmitter 706 for transmission. The RF transmitter 706 can be a Wi-Fi transmitter, a 5G/NR transmitter, a Bluetooth™ transmitter, or any other transmitter capable of transmitting an RF signal.

RF transmitter 706 can be coupled to one or more transmitting antennas such as Tx antenna 712. In some examples, transmit (Tx) antenna 712 can be an omnidirectional antenna that is capable of transmitting an RF signal in all directions. For example, Tx antenna 712 can be an omnidirectional Wi-Fi antenna that can radiate Wi-Fi signals (e.g., 2.4 GHZ, 5 GHZ, 6 GHZ, etc.) in a 360-degree radiation pattern. In another example, Tx antenna 712 can be a directional antenna that transmits an RF signal in a particular direction.

In some examples, wireless device 700 can also include one or more components for receiving an RF signal. For example, the receiver lineup in wireless device 700 can include one or more receiving antennas such as a receive (Rx) antenna 714. In some examples, Rx antenna 714 can be an omnidirectional antenna capable of receiving RF signals from multiple directions. In other examples, Rx antenna 714 can be a directional antenna that is configured to receive signals from a particular direction. In further examples, both the Tx antenna 712 and the Rx antenna 714 can include multiple antennas (e.g., elements) configured as an antenna array.

Wireless device 700 can also include an RF receiver 710 that is coupled to Rx antenna 714. RF receiver 710 can include one or more hardware components for receiving an RF waveform such as a Wi-Fi signal, a Bluetooth™ signal, a 5G/NR signal, or any other RF signal. The output of RF receiver 710 can be coupled to an ADC 708. ADC 708 can be configured to convert the received analog RF waveform into a digital waveform. The digital waveform that is the output of the ADC 708 can be provided to the processor(s) 722 for processing. The processor(s) 722 (e.g., a digital signal processor (DSP)) can be configured for processing the digital waveform.

In one example, wireless device 700 can implement RF sensing techniques, for example monostatic sensing techniques, by causing a Tx waveform 716 to be transmitted from Tx antenna 712. Although Tx waveform 716 is illustrated as a single line, in some cases, Tx waveform 716 can be transmitted in all directions by an omnidirectional Tx antenna 712. In one example, Tx waveform 716 can be a Wi-Fi waveform that is transmitted by a Wi-Fi transmitter in wireless device 700. In some cases, Tx waveform 716 can correspond to a Wi-Fi waveform that is transmitted at or near the same time as a Wi-Fi data communication signal or a Wi-Fi control function signal (e.g., a beacon transmission). In some examples, Tx waveform 716 can be transmitted using the same or a similar frequency resource as a Wi-Fi data communication signal or a Wi-Fi control function signal (e.g., a beacon transmission). In some aspects, Tx waveform 716 can correspond to a Wi-Fi waveform that is transmitted separately from a Wi-Fi data communication signal and/or a Wi-Fi control signal (e.g., Tx waveform 716 can be transmitted at different times and/or using a different frequency resource).

In some examples, Tx waveform 716 can correspond to a 5G NR waveform that is transmitted at or near the same time as a 5G NR data communication signal or a 5G NR control function signal. In some examples, Tx waveform 716 can be transmitted using the same or a similar frequency resource as a 5G NR data communication signal or a 5G NR control function signal. In some aspects, Tx waveform 716 can correspond to a 5G NR waveform that is transmitted separately from a 5G NR data communication signal and/or a 5G NR control signal (e.g., Tx waveform 716 can be transmitted at different times and/or using a different frequency resource).

In some aspects, one or more parameters associated with Tx waveform 716 can be modified that may be used to increase or decrease RF sensing resolution. The parameters may include frequency, bandwidth, number of spatial streams, the number of antennas configured to transmit Tx waveform 716, the number of antennas configured to receive a reflected RF signal (e.g., Rx waveform 718) corresponding to Tx waveform 716, the number of spatial links (e.g., number of spatial streams multiplied by number of antennas configured to receive an RF signal), the sampling rate, or any combination thereof. The transmitted waveform (e.g., Tx waveform 716) and the received waveform (e.g., Rx waveform 718) can include one or more RF sensing signals, which are also referred to as radar reference signals (RSS).

In further examples, Tx waveform 716 can be implemented to have a sequence that has perfect or almost perfect autocorrelation properties. For instance, Tx waveform 716 can include single carrier Zadoff sequences or can include symbols that are similar to orthogonal frequency-division multiplexing (OFDM) Long Training Field (LTF) symbols. In some cases, Tx waveform 716 can include a chirp signal, as used, for example, in a Frequency-Modulated Continuous-Wave (FM-CW) radar system. In some configurations, the chirp signal can include a signal in which the signal frequency increases and/or decreases periodically in a linear and/or an exponential manner.

In some aspects, wireless device 700 can implement RF sensing techniques by performing alternating transmit and receive functions (e.g., performing a half-duplex operation). For example, wireless device 700 can alternately enable its RF transmitter 706 to transmit the Tx waveform 716 when the RF receiver 710 is not enabled to receive (i.e. not receiving), and enable its RF receiver 710 to receive the Rx waveform 718 when the RF transmitter 706 is not enabled to transmit (i.e. not transmitting). When the wireless device 700 is performing a half-duplex operation, the wireless device 700 may transmit Tx waveform 716, which may be a radar RS (e.g., sensing signal).

In other aspects, wireless device 700 can implement RF sensing techniques by performing concurrent transmit and receive functions (e.g., performing a sub-band or full-band full-duplex operation). For example, wireless device 700 can enable its RF receiver 710 to receive at or near the same time as it enables RF transmitter 706 to transmit Tx waveform 716. When the wireless device 700 is performing a full-duplex operation (e.g., either sub-band full-duplex or full-band full-duplex), the wireless device 700 may transmit Tx waveform 716, which may be a radar RS (e.g., sensing signal).

In some examples, transmission of a sequence or pattern that is included in Tx waveform 716 can be repeated continuously such that the sequence is transmitted a certain number of times or for a certain duration of time. In some examples, repeating a pattern in the transmission of Tx waveform 716 can be used to avoid missing the reception of any reflected signals if RF receiver 710 is enabled after RF transmitter 706. In one example implementation, Tx waveform 716 can include a sequence having a sequence length L that is transmitted two or more times, which can allow RF receiver 710 to be enabled at a time less than or equal to L in order to receive reflections corresponding to the entire sequence without missing any information.

By implementing alternating or simultaneous transmit and receive functionality (e.g. half-duplex or full-duplex operation), wireless device 700 can receive signals that correspond to Tx waveform 716. For example, wireless device 700 can receive signals that are reflected from objects or people that are within range of Tx waveform 716, such as Rx waveform 718 reflected from target 702. Wireless device 700 can also receive leakage signals (e.g., Tx leakage signal 720) that are coupled directly from Tx antenna 712 to Rx antenna 714 without reflecting from any objects. For example, leakage signals can include signals that are transferred from a transmitter antenna (e.g., Tx antenna 712) on a wireless device to a receive antenna (e.g., Rx antenna 714) on the wireless device without reflecting from any objects. In some cases, Rx waveform 718 can include multiple sequences that correspond to multiple copies of a sequence that are included in Tx waveform 716. In some examples, wireless device 700 can combine the multiple sequences that are received by RF receiver 710 to improve the signal to noise ratio (SNR).

Wireless device 700 can further implement RF sensing techniques by obtaining RF sensing data associated with each of the received signals corresponding to Tx waveform 716. In some examples, the RF sensing data can include channel state information (CSI) data relating to the direct paths (e.g., leakage signal 720) of Tx waveform 716 together with data relating to the reflected paths (e.g., Rx waveform 718) that correspond to Tx waveform 716.

In some aspects, RF sensing data (e.g., CSI data) can include information that can be used to determine the manner in which an RF signal (e.g., Tx waveform 716) propagates from RF transmitter 706 to RF receiver 710. RF sensing data can include data that corresponds to the effects on the transmitted RF signal due to scattering, fading, and/or power decay with distance, or any combination thereof. In some examples, RF sensing data can include imaginary data and real data (e.g., I/Q components) corresponding to each tone in the frequency domain over a particular bandwidth.

In some examples, RF sensing data can be used by the processor(s) 722 to calculate distances and angles of arrival that correspond to reflected waveforms, such as Rx waveform 718. In further examples, RF sensing data can also be used to detect physical characteristics, detect motion, determine location, detect changes in location or motion patterns, obtain channel estimation, or any combination thereof. In some cases, the distance and angle of arrival of the reflected signals can be used to identify the size, position, movement, or orientation of users in the surrounding environment (e.g., target 702) in order to detect user presence/proximity, detect user attention, and/or perform facial recognition as well as user authentication (e.g., facial authentication). In some examples, RF sensing data can be used to determine an RF signature associated with target 702. In some instance, the RF signature can be based on one or more physical attributes of target 702 (e.g., height, width, proportions, limbs, head size, etc.) determined based on the RF sensing data.

The processor(s) 722 of the wireless device 700 can calculate distances and angles of arrival corresponding to reflected waveforms (e.g., the distance and angle of arrival corresponding to Rx waveform 718) by utilizing signal processing, machine learning algorithms, any other suitable technique, or any combination thereof. In other examples, wireless device 700 can transmit or send the RF sensing data to at least one processor of another computing device, such as a server or base station, that can perform the calculations to obtain the distance and angle of arrival corresponding to Rx waveform 718 or other reflected waveforms.

In one example, the distance of Rx waveform 718 can be calculated by measuring the difference in time from reception of the leakage signal to the reception of the reflected signals. For example, wireless device 700 can determine a baseline distance of zero that is based on the difference from the time the wireless device 700 transmits Tx waveform 716 to the time it receives leakage signal 720 (e.g., propagation delay). The processor(s) 722 of the wireless device 700 can then determine a distance associated with Rx waveform 718 based on the difference from the time the wireless device 700 transmits Tx waveform 716 to the time it receives Rx waveform 718 (e.g., time of flight, which is also referred to as round trip time (RTT)), which can then be adjusted according to the propagation delay associated with leakage signal 720. In doing so, the processor(s) 722 of the wireless device 700 can determine the distance traveled by Rx waveform 718 which can be used to determine the presence and movement of a target (e.g., target 702) that caused the reflection.

In further examples, the angle of arrival of Rx waveform 718 can be calculated by the processor(s) 722 by measuring the time difference of arrival of Rx waveform 718 between individual elements of a receive antenna array, such as antenna 714. In some examples, the time difference of arrival can be calculated by measuring the difference in received phase at each element in the receive antenna array.

In some cases, the distance and the angle of arrival of Rx waveform 718 can be used by processor(s) 722 to determine the distance between wireless device 700 and target 702 as well as the position of the target 702 relative to the wireless device 700. The distance and the angle of arrival of Rx waveform 718 can also be used to determine presence, movement, proximity, identity, or any combination thereof, of target 702. For example, the processor(s) 722 of the wireless device 700 can utilize the calculated distance and angle of arrival corresponding to Rx waveform 718 to determine that the target 702 is moving towards wireless device 700.

As noted above, wireless device 700 can include mobile devices (e.g., IoT devices, smartphones, laptops, tablets, etc.) or other types of devices. In some examples, wireless device 700 can be configured to obtain device location data and device orientation data together with the RF sensing data. In some instances, device location data and device orientation data can be used to determine or adjust the distance and angle of arrival of a reflected signal such as Rx waveform 718. For example, wireless device 700 may be set on a table facing the ceiling as a target 702 (e.g., a user) moves (e.g., walks) towards it during the RF sensing process. In this instance, wireless device 700 can use its location data and orientation data together with the RF sensing data to determine the direction that the target 702 is moving.

In some examples, device position data can be gathered by wireless device 700 using techniques that include RTT measurements, time of arrival (TOA) measurements, time difference of arrival (TDOA) measurements, passive positioning, angle of arrival (AoA), received signal strength indicator (RSSI), CSI data, using any other suitable technique, or any combination thereof. In further examples, device orientation data can be obtained from electronic sensors on the wireless device 700, such as a gyroscope, an accelerometer, a compass, a magnetometer, a barometer, any other suitable sensor, or any combination thereof.

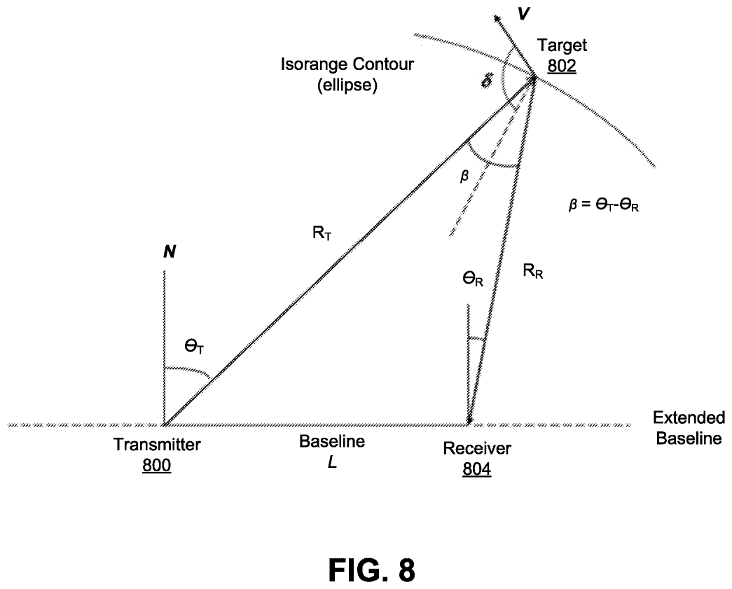

FIG. 8 is a diagram illustrating geometry for sensing (e.g., monostatic or bistatic sensing), in accordance with some examples. FIG. 8 shows a bistatic radar North-reference coordinate system in two-dimensions. In particular, FIG. 8 shows a coordinate system and parameters defining bistatic radar operation in a plane (referred to as a bistatic plane) containing a transmitter 800, a receiver 804, and a target 802. A bistatic triangle lies in the bistatic plane. The transmitter 800, the target 802, and the receiver 804 are shown in relation to one another. The transmitter 800 and the receiver 804 are separated by a baseline distance L. The extended baseline is defined as continuing the baseline distance L beyond either the transmitter 800 or the receiver 804. The target 802 and the transmitter 800 are separated by a distance R_{T}, and the target 802 and the receiver 804 are separated by a distance R_{R}.

Angles θ_{T} and θ_{R} are, respectively, the transmitter 800 and receiver 804 look angles, which are taken as positive when measured clockwise from North (N). The angles θ_{T} and θ_{R} are also referred to as angles of arrival (AOA) or lines of sight (LOS). A bistatic angle (B) is the angle subtended between the transmitter 800, the target 802, and the receiver 804 in the radar. In particular, the bistatic angle is the angle between the transmitter 800 and the receiver 804 with the vertex located at the target 802. The bistatic angle is equal to the transmitter 800 look angle minus the receiver 804 look angle θ_{R} (e.g., β=θ_{T}−θ_{R}).

When the bistatic angle is exactly zero (0), the radar is considered to be a monostatic radar; when the bistatic angle is close to zero, the radar is considered to be pseudo-monostatic; and when the bistatic angle is close to 180 degrees, the radar is considered to be a forward scatter radar. Otherwise, the radar is simply considered to be, and referred to as, a bistatic radar. The bistatic angle (β) can be used in determining the radar cross section of the target.

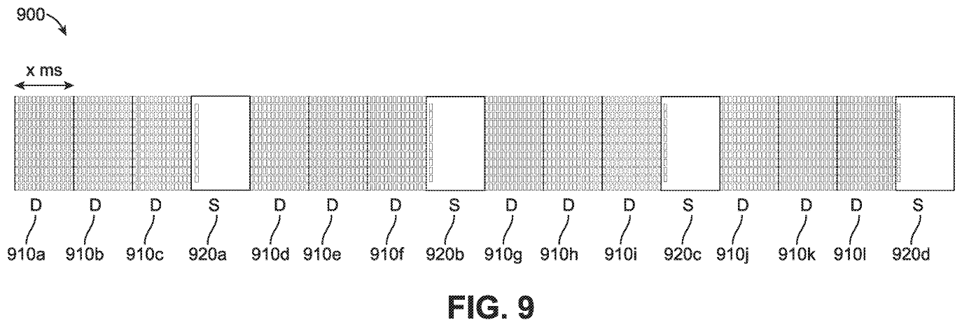

FIG. 9 is a diagram illustrating an example frame structure 900 with TDD multiplexing, which may be employed by the disclosed systems and techniques for a phase continuity configuration in CLI-based sensing (e.g., for signaling for communications and/or sensing purposes), in accordance with some examples. In FIG. 9, the frame structure 900 includes a plurality of resource blocks (RBs) (e.g., RBs of FIG. 4), which each include a plurality of symbols (e.g., OFDM symbols of FIG. 4). In particular, the frame structure 900 is shown to include sixteen (16) RBs, which include RBs 910a, 910b, 910c, 910d, 910e, 910f, 910g, 910h, 910i, 910j, 910k, and 9101 (referred to collectively as RBs 910a-9101) dedicated for downlink communications (e.g., which are denoted by the letter “D”) and 920a, 920b, 920c, and 920d (referred to collectively as RBs 920a-920d) dedicated for sensing (e.g., which are denoted by the letter “S”). In FIG. 9, time is represented horizontally (e.g., on the X axis) with time increasing from left to right, while frequency is represented vertically (e.g., on the Y axis) with frequency increasing (or decreasing) from bottom to top.

For example, during operation for Doppler estimation, sensing signals, such as radar reference signals (RSS), are transmitted periodically by a radar transmitter (e.g., RF transmitter 706 of FIG. 7) and received by a radar receiver (e.g., RF receiver 710 of FIG. 7) during the RBs 920a-920d dedicated for sensing (e.g., which are denoted by the letter “S”). At least one processor (e.g., processor 722 of FIG. 7) may estimate the Doppler by using the received signals. For example, for the Doppler estimation, obtained sensing data (A, B) may be utilized, where “A” is equal to the number of observations of RSs used, with one RS per “B” number of symbols.

Doppler resolution is one metric used to estimate the quality of the received signal. Doppler resolution relies on the observation window over the RSs. Each RB 910a-9101, 920a-920d of the frame structure 900 may have a slot duration of x ms (e.g., 0.5 ms). For example, with a slot duration of 0.5 ms for each of the RBs 910a-9101, 920a-920d, the doppler resolution may be equal to 125 Hertz (Hz) and a maximum resolvable Doppler may be equal to 2000 Hz.

In RF sensing, especially for micro-Doppler estimation, two adjacent RSs may be separated by a long duration in the time domain. When this is the case, it can be challenging for the radar transmitter to maintain phase continuity with such a long duration for the Doppler estimation. One reason why it is challenging for the radar transmitter to maintain phase continuity is that, for example, in the downlink transmission, the power amplifier (PA) state for the transmission of the radar RSs and the single sidebands (SSBs) may be different and, as such, the transmitter phase may change when there is a SSB transmitted between two radar RSs. Another reason why it is challenging for the radar transmitter to maintain phase continuity is that, similarly, in the uplink/sidelink (UL/SL) transmission, other RS or channel transmissions may break the phase continuity at the transmitter, which is required for radar signal bundling.

It should be noted that in order to achieve a high resolution Doppler estimation, which is desired, the observation window must be long enough to observe the RSs. Within this observation window, the phase should be continuous between the adjacent RSs in order to ensure an accurate Doppler estimation.

FIG. 10 is a diagram illustrating an example of obtaining micro-Doppler measurements, which may be performed by the disclosed systems and techniques for a phase continuity configuration in CLI-based sensing, in accordance with some examples. As previously mentioned, Doppler estimation requires phase continuity between adjacent sensing signals (e.g., RSs).

Micro-Doppler estimation leverages the phase variation of the received sensing signal. For example, for vital sign detection of breathing of a person (e.g., a user), chest displacement of the person is tracked in the time domain. The following are equations for obtaining the phase of the received sensing signal.

$$I + iQ = {Re}^{i φ} \qquad ( equation 1 )$$

$$φ ( t ) = ( 4 π / t ) x ( t ) \qquad ( equation 2 )$$

In equations 1 and 2, x(t) is the real chest displacement in the breathing of the person at time equal to t, and φ(t) is equal to the phase of the received sensing signal, which is associated with x(t). From these two equations, the phase φ(t) can be extracted from the complex received sensing signal I+iQ.

FIG. 10 depicts a system 1000 employing a UE 1004 that is monitoring the breathing of two users 1002a, 1002b. One of the users 1002a is located closer to UE 1004 than the other user 1002b. For example, user 1002a may be located at a distance of 30 centimeters (cm) away from UE 1004, while user 1002b may be located at a distance of 50 cm away from UE 1004.

During operation of the system 1000, UE 1004 transmits sensing signals (e.g., RSs) 1006a, 1006b towards both users 1002a, 1002b. The sensing signals reflect off of the users 1002a, 1002b to produce reflection signals 1008a, 1008b, which are reflected back towards the UE 1004. The UE 1004 receives the reflection signals 1008a, 1008b from both of the users 1002a, 1002b, and uses the reflection signals 1008a, 1008b to generate Doppler estimates.

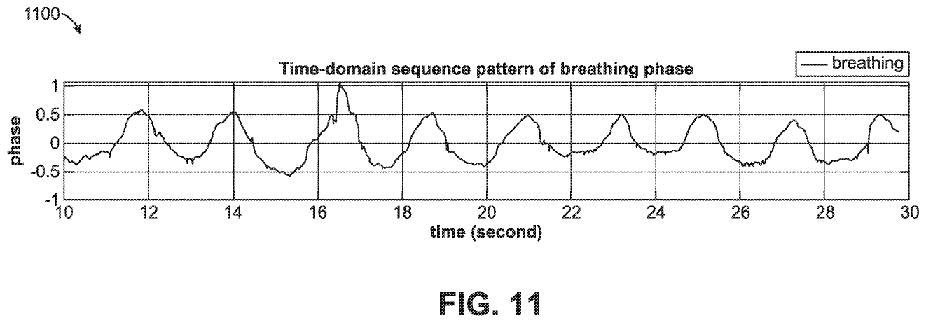

FIG. 11 is a graph 1100 illustrating an example phase variation pattern of breathing by a user obtained from micro-Doppler measurements, in accordance with some examples. In the graph 1100, the x-axis represents time in seconds, and the y-axis represents a normalized phase.

For example, the graph 1100 of FIG. 11 shows an example phase variation pattern of breathing by one of the users 1002a, 1002b of the system 1000 of FIG. 10. The phase variation pattern of breathing by a user may be tracked for a long time (e.g., for at least one minute in duration). The phase variation of the graph 1100 represents the breathing information of the user, with an assumption that the phase variation is mainly from the antenna (e.g., of the UE 1004) displacement from the user. In particular, one breathing cycle of the user is mapped to a peak and an adjacent valley of the phase variation pattern of the graph 1100. Since the phase variation pattern is clear and evident in the graph 1100, it can be assumed that the transmitted RS waveform has a continuous phase.

FIG. 12 is a diagram depicting an example of the occurrence of CLI in a system 1200, in accordance with some examples. The system 1200 of FIG. 12 may include UEs 1215a, 1215b (e.g., wireless device 700 of FIG. 7, which may be a smart phone), base stations (e.g., gNBs) 1205a, 1205b. The UE (e.g., UE1) 1215a and the base station 1205a may be located within a first cell (e.g., cell 1) 1210a. In some aspects, the UE (e.g., UE2) 1215b and the base station 1205b may be located within a second cell (e.g., cell 2) 1210b.

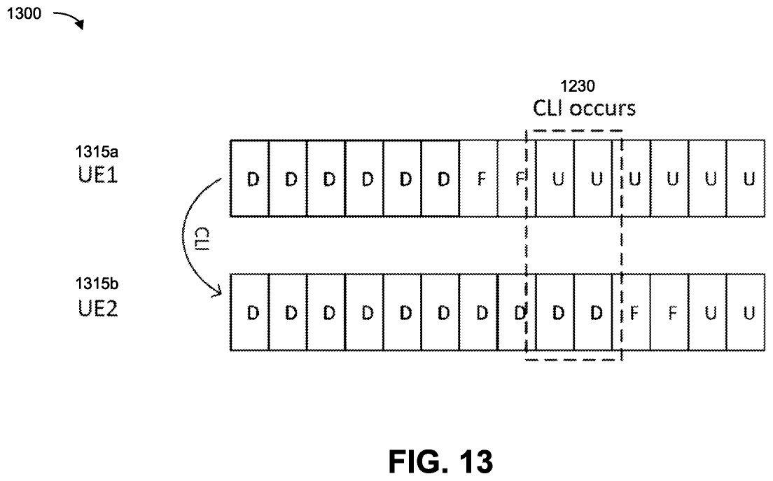

The system 1200 may employ TDD communications, which is used for both uplink and downlink transmissions. FIG. 13 is a diagram illustrating example TDD configurations 1300 (e.g., including TDD configuration 1315a and TDD configuration 1315b) for the system 1200 of FIG. 12, in accordance with some examples. Each of the cells 1210a, 1210b of FIG. 12 may have a different TDD configuration 1315a, 1315b. For example, the first cell 1210a may have a first TDD configuration 1315a, and the second cell 1210b may have a second TDD configuration 1315b. The network devices (e.g., UEs 1215a, 1215b, and base stations 1205a, 1205b) may communicate using their TDD configuration associated with their particular cell. For example, the UE (e.g., UE1) 1215a and the base station 1205a located within the first cell (e.g., cell 1) 1210a may communicate using the first TDD configuration 1315a. In some cases, the UE (e.g., UE2) 1215b and the base station 1205b located within the second cell (e.g., cell 2) 1210b may communicate using the second TDD configuration 1315b.

Each TDD configuration 1315a, 1315b may include a plurality of symbols (e.g., OFDM symbols of FIG. 4). The symbols of a slot (e.g., slot of FIG. 4) may be designated as “downlink” (e.g., represented by a “D” letter) for downlink transmissions, “uplink” (e.g., represented by a “U” letter) for uplink transmissions, “flexible” (e.g., represented by an “F” letter), and/or “sensing” (e.g., represented by an “SRS” for sounding reference signal). The flexible symbol “F” can be configured for either uplink or downlink transmissions. The flexible symbol “F” can be utilized as a guard period between the uplink transmissions and the downlink transmissions to prevent inter-symbol interference and/or to provide time for a UE to adjust its RF hardware.

Each of the base stations 1205a, 1205b may transmit a downlink signal (e.g., signals 1225a, 1225b) on a downlink symbol (e.g., “D” symbol). In some cases, each of the UEs 1215a, 1215b may transmit an uplink signal (e.g., signals 1225a, 1225b) on an uplink symbol (e.g., “U” symbol). Each of the UEs 1215a, 1215b may transmit a sensing signal (e.g., an SRS) in an uplink transmission on a sensing symbol (e.g., “SRS” symbol). In some cases, another UE (e.g., UEs 1215a, 1215b), or a base station (e.g., base stations 1205a, 1205b), may receive a reflection sensing signal generated from the sensing signal.

In some cases, neighboring cells with different TDD configurations may lead to conflicting (overlapping) transmissions for some symbols of a slot. The TDD configurations 1300 of FIG. 13, for example, exhibit conflicting transmissions in the ninth and tenth slots of TDD configuration 1315a and TDD configuration 1315b. In particular, for these two specific slots (e.g., the ninth and tenth slots), an uplink transmission (e.g., denoted by the letter “U”) and a downlink transmission (e.g., denoted by the letter “D”) are configured to occur at the same frequency at the same time for these two adjacent cells 1210a, 1210b. For example, UE 1215a in cell 1210a may be configured to transmit an uplink transmission (e.g., signal 1225a) at the same time UE 1215b in cell 1210b may be configured to receive a downlink transmission (e.g., signal 1225b). Since these UEs 1215a, 1215b are nearby each other in neighboring cells 1210a, 1210b, the uplink transmission of UE 1215a may cause an interference in the downlink reception of UE 1215b. This type of interference is referred to as CLI and, in particular, as UE-to-UE CLI (e.g., which is denoted by link 1230 of FIG. 12). The UE 1215a transmitting the uplink signal may be referred to as the “aggressor UE,” and the UE 1215b receiving the affected downlink transmission (e.g., containing interference) may be referred to as the “victim UE.” The CLI is transparent to the aggressor UE (e.g., UE 1215a). It should be noted that CLI in the system 1200 may occur on additional links (e.g., links 1210, 1220a, 1220b) other than on link 1230.

In order to manage the CLI, the UEs 1215a, 1215b may measure the CLI strength, which may be represented by received reference signal power (RSRP) and received signal strength indicator (RSSI) metrics. These metrics may be used to determine whether more interference may be tolerated by the victim UE. In one or more examples, the RSRP and/or the RSSI may be measured by the UEs 1215a, 1215b using various different methods. For example, a UE 1215a, 1215b may demodulate a reference signal, perform channel estimation of the demodulated reference signal, and measure the RSRP based on the channel estimation. In another example, RSSI may be indicative of a total received signal power from all signals received by a UE 1215a, 1215b, and may be measured in the symbols of a slot where the CLI is present.

In one or more examples, the RSRP and RSSI measurements may be performed on respective reference signals transmitted by an aggressor UE. For example, the aggressor UE may transmit a first set of CLI reference signals (e.g., CLI-RSs) to enable a victim UE to measure the RSRP of the CLI-RSs, and/or transmit a second set of CLI-RSs to enable the victim UE to measure an RSSI o the CLI-RSs. In some examples, the CLI-RSs may be existing reference signals that a victim UE measures to determine different metrics about the CLI. For example, the CLI-RSs may include sounding reference signals (SRSs), channel state information reference signals (CSI-RSs), and/or other similar signals that an aggressor UE may transmit during a corresponding downlink symbol for a victim UE. The victim UE may then measure the CLI strength based on at least one of the received CLI-RSs from the aggressor UE.

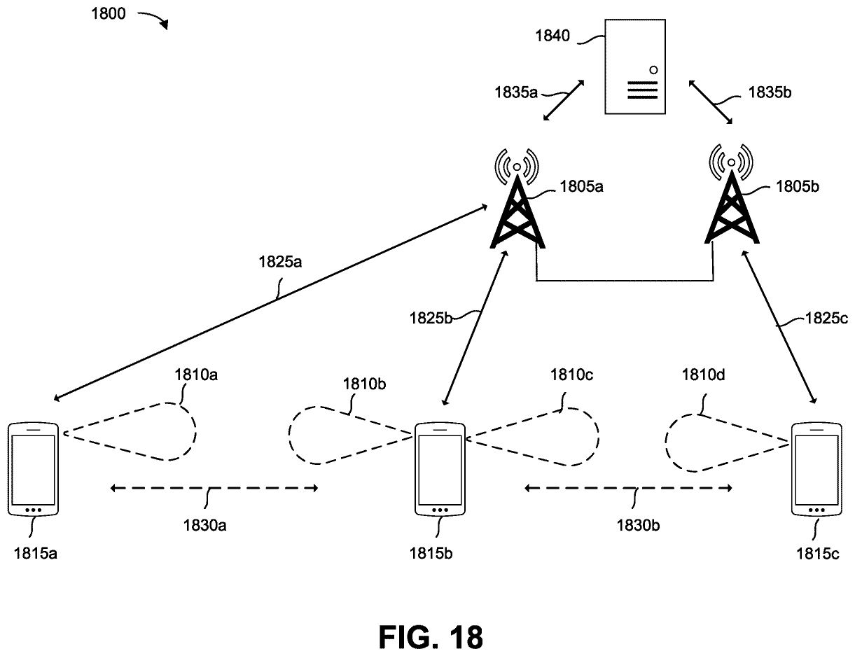

3GPP Release 16 has defined layer 3 measurement and reporting procedures for the interference management amongst UEs (e.g., UEs 1215a, 1215b). In particular, Release 16 provides procedures to measure UE-to-UE CLI (e.g., which is denoted by link 1230 of FIG. 12), and to report the CLI measurements to the network. The measurement procedure of the CLI may utilize CLI-RSs including SRS resources and RSSI resources to measure RSRP and RSSI, respectively. The measurement resource configuration may include periodicity, frequency of RBs, and OFDM symbols where the CLI is present. The UEs (e.g., UEs 1215a, 1215b) may then report the measured RSRP and RSSI to the network (e.g., network entity 1840 or network server of FIG. 18), which may then determine a phase compensation based on the received RSRP and/or RSSI measurements. It should be noted that Release 16 does not provide procedures to measure and/or to report phase continuity related to CLI.

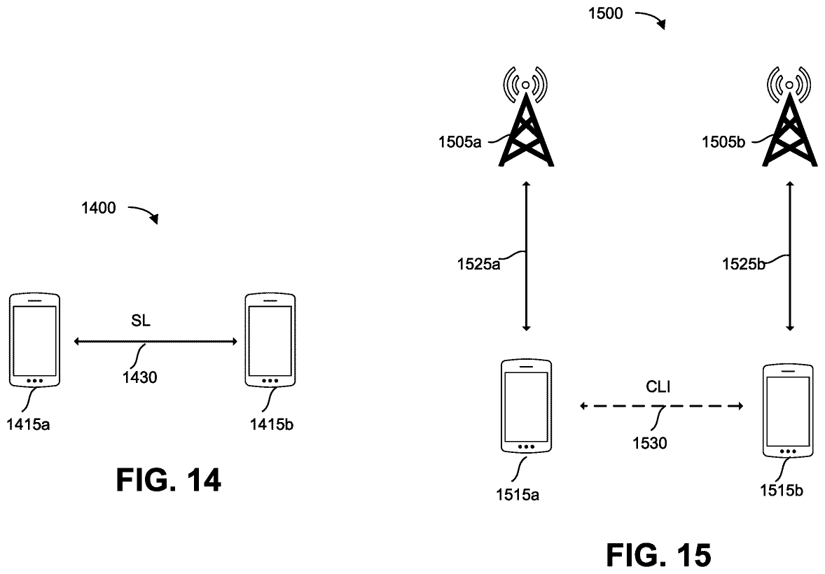

CLI sensing has many benefits, especially when compared to sidelink-based sensing. FIG. 14 is a diagram depicting an example of sidelink-based sensing in a system 1400, in accordance with some examples. FIG. 15 (as a comparison to sidelink-based sensing in FIG. 14) is a diagram depicting an example of CLI-based sensing in a system 1500, in accordance with some examples.

In FIG. 14, two UEs 1415a, 1415b may perform sensing (e.g., monostatic sensing) with each other, thereby generating a sidelink-based sensing signal 1430. During operation, UE 1415a may transmit a sensing signal 1430 towards UE 1415b. The sensing signal 1430 reflects off of UE 1415b to generate a reflection signal 1430 that radiates towards UE 1415a. UE 1415a receives the reflection signal 1430 and uses the reflection signal 1430 to estimate Doppler. Similarly, during operation, UE 1415b may transmit a sensing signal 1430 towards UE 1415a. The sensing signal 1430 reflects off of UE 1415a to generate a reflection signal 1430 that radiates towards UE 1415b. UE 1415b receives the reflection signal 1430 and uses the reflection signal 1430 to estimate Doppler.

In FIG. 15, two UEs 1515a, 1515b may transmit and receive signals 1525a, 1525b to and from respective base stations 1505a, 1505b, thereby generating a CLI-based sensing signal 1530. It should be noted that the generation of CLI is explained in detail in the discussion of FIGS. 12 and 13.

Sidelink-based sensing, as shown in FIG. 14, requires a dedicated connection between the nodes (e.g., UEs 1415a, 1415b), and the nodes (e.g., UEs 1415a, 1415b) themselves are transmitting the sidelink-based sensing signal 1430. Conversely, in CLI-based sensing, the nodes (e.g., UEs 1515a, 1515b) only need to be connected to their respective base station 1505a, 1505b and, as such, the nodes (e.g., UEs 1515a, 1515b) do not need to build direct connections with each other (or with other adjacent nodes). Also, in CLI-based sensing, the nodes (e.g., UEs 1415a, 1415b) themselves are not transmitting the CLI-based sensing signal 1530.

Considered as co-operative sensing. CLI-based sensing may occur between any two adjacent nodes (e.g., UEs 1515a, 1515b), and is not constrained to connect between the nodes (e.g., UEs 1515a, 1515b) as a sidelink. As such, when comparing CLI-based sensing to sidelink-based sensing, CLI-based sensing can cover all directions without any needed dedication synchronization and connection, as is required with sidelink-based sensing. As such, CLI-based sensing may be beneficial to use (as compared to sidelink-based sensing) for sensing purposes.

As previously mentioned, in micro-Doppler measurements, it is important to have phase continuity of the signal in order to obtain a clear and evident phase variation pattern. However, when utilizing TDD multiplexing communications, it can be challenging for the transmitter/receiver to be able to maintain phase continuity within multiple radar sensing signal instances.

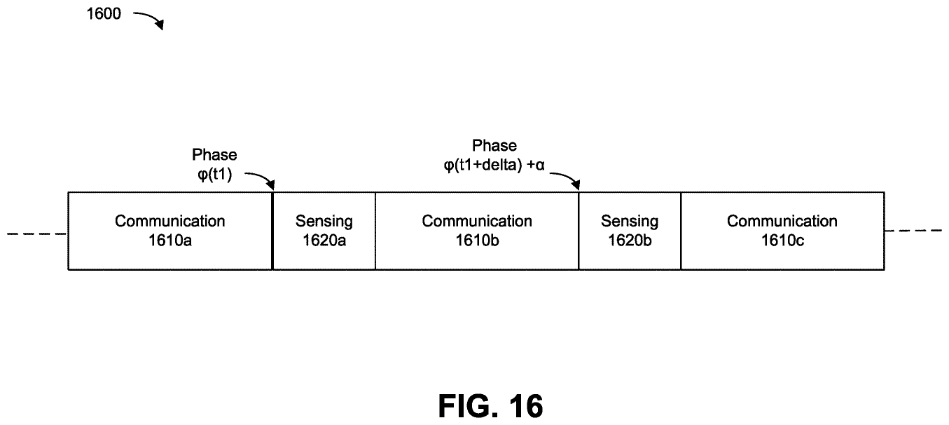

For example, FIG. 16 is a diagram illustrating an example frame structure 1600 with TDD multiplexing that is exhibiting phase jumping, in accordance with some examples. In FIG. 16, the frame structure 1600 may include a plurality of communications resources 1610a, 1610b, 1610c, and a plurality of sensing resources 1620a, 1620b. It should be noted that within each of the resources (e.g., communications resources and/or sensing resources) themselves, which may be referred to as intra resource, there may be phase continuity.

However, from resource to resource, which may be referred to as inter resource, phase jumping may occur at the transitions between the different types of resources (e.g., at the transition between a communication resource and a sensing resource). As shown in the frame structure 1600, in a TDD multiplexing configuration, each sensing resource 1620a, 1620b may have one random phase jump at the transitions between the communication resources and the sensing resources. For example, the transition between communication resource 1610a and sensing resource 1620a has a phase equal to φ(t1), where φ(t) is the phase variation during the time t that has phase continuity. The transition between communication resource 1610b and sensing resource 1620b has a phase equal to φ(t1+delta)+α, where φ is the unknown phase jump, as compared to φ(t), and delta is a constant.

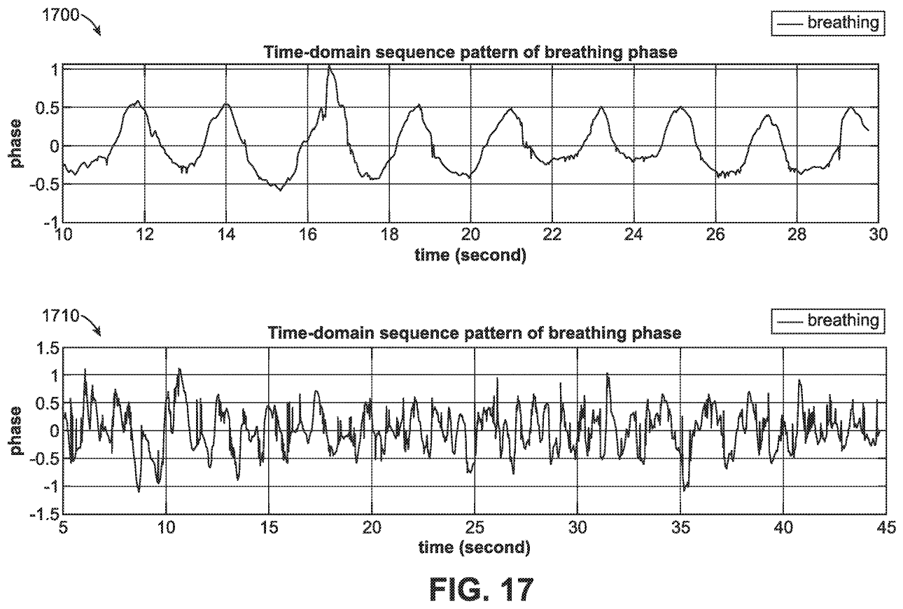

FIG. 17 includes two graphs, where one graph 1700 depicts an example phase pattern with phase continuity and another graph 1710 depicts an example pattern with phase jumping, in accordance with some examples. In each of the graphs 1700 and 1710, the x-axis represents time in seconds, and the y-axis represents a normalized. The graph 1700 shows an example phase variation pattern with phase continuity that exhibits clear and evident peaks and valleys within the pattern of the graph 1700. As such, the phase variation pattern of graph 1700 may be an ideal extracted phase pattern with continuous phase. Conversely, the graph 1710 shows an example pattern with phase jumping (e.g., without continuous phase), where the phase jumping has destroyed the phase pattern (e.g., the pattern of graph 1710 does not display clear peaks and valleys of the phase).

FIG. 18 is a diagram illustrating the disclosed system 1800 for a phase continuity configuration in CLI-based sensing, in accordance with some examples. The system 1800 of FIG. 18 may include network devices, which are in the form of UEs 1815a, 1815b, 1815c (e.g., wireless device 700 of FIG. 7, which may be a smart phone); base stations (e.g., gNBs) 1805a, 1805b; and a network entity (e.g., network server) 1840. In the system 1800, the UE 1815a may be located within a first cell, the UE 1815b may be located within a second cell 1210b, and the UE 1815c may be located within a third cell. It should be noted that, in one or more examples, the system 1800 may employ more or less network devices (e.g., UEs), base stations, network entities, and/or cells, than as is shown in FIG. 18.

The system 1800 may employ TDD communications. Each of the three cells may have a different TDD configuration (e.g. TDD configuration 1315a and TDD configuration 1315b of FIG. 13). For example, the first cell may have a first TDD configuration, the second cell may have a second TDD configuration, and the third cell may have a third TDD configuration. The network devices (e.g., UEs 1815a, 1815b, 1815c) may communicate using the TDD configuration associated with their particular cell.

Each of the TDD configurations may include a plurality of symbols (e.g., OFDM symbols of FIG. 4), which may each be designated as “downlink” (e.g., represented “D” or “DL”) for downlink transmissions, “uplink” (e.g., represented by “U” or “UL”) for uplink transmissions, “flexible” (e.g., represented by “F”), and/or “sensing” (e.g., represented by “SRS”). The flexible symbol “F” may be configured for either uplink or downlink transmissions.

Each of the base stations 1805a, 1805b may transmit a downlink signal (e.g., signals 1825a, 1825b, 1825c) on a downlink symbol (e.g., a “D” or “DL” symbol). Each of the UEs 1815a, 1815b, 1815c may transmit an uplink signal (e.g., signals 1825a, 1825b, 1825c) on an uplink symbol (e.g., a “U” or “UL” symbol). Each of the UEs 1815a, 1815b, 1815c may transmit a sensing signal (e.g., an SRS) in an uplink transmission on a sensing symbol (e.g., an “SRS” symbol). Another UE (e.g., UEs 1815a, 1815b, 1815c) other than the transmitting UE, or a base station (e.g., base stations 1805a, 1805b), may then receive a reflection sensing signal generated from the sensing signal (e.g., SRS).

Nearby cells with different TDD configurations can lead to conflicting (overlapping) transmissions for some symbols of a slot (e.g., the TDD configurations 1300 of FIG. 13, for example, exhibit conflicting uplink and downlink transmissions at the same time, in the ninth and tenth slots, at the same frequency of TDD configuration 1315a and TDD configuration 1315b). For example, UE 1815b may be configured to transmit an uplink transmission (e.g., signal 1825b) at the same time UE 1815a may be configured to receive a downlink transmission (e.g., signal 1825a). Since the UEs 1815a, 1815b are nearby each other in neighboring cells (e.g., the first and second cells), the uplink transmission of UE 1815b may cause an interference in the downlink reception of UE 1815a. Also, for example, UE 1815b may be configured to transmit an uplink transmission (e.g., signal 1825b) at the same time UE 1815c may be configured to receive a downlink transmission (e.g., signal 1825c). Since the UEs 1815b, 1815c are nearby each other in neighboring cells (e.g., the second and third cells), the uplink transmission of UE 1815b may cause an interference in the downlink reception of UE 1815c.

The interference (e.g., the interference in the downlink reception of UE 1215a and the interference in the downlink reception of UE 1215c) is CLI (e.g., CLI 1830a, 1830b). The UEs (e.g., UEs 1815c) transmitting the uplink signal can be referred to as aggressor UEs, and the UEs (e.g., UEs 1815a, 1815c) receiving the downlink transmission (which is affected by interference) may be referred to as victim UEs.

In one or more examples, the UEs (e.g., UEs 1815a, 1815b, 1815c) involved in the CLI (e.g., CLI 1830a, 1830b) may measure the CLI strength (e.g., which may be represented by RSRP and/or RSSI metrics) for management of the CLI. The CLI strength may be used to determine whether a victim UE (e.g., UEs 1815a, 1815c) can tolerate more interference or not. The UEs (e.g., UEs 1815a, 1815b, 1815c) may employ various different measurement techniques to measure the CLI strength (e.g., to measure the RSRP and/or RSSI metrics).

In one or more examples, the RSRP and/or RSSI measurements may be performed on reference signals (e.g., CLI-RSs 1810a, 1810b, 1810c, 1810d) transmitted by an aggressor UE and received by a victim UE. For example, an aggressor UE (e.g., UE 1815b) may transmit a first set of CLI reference signals (e.g., CLI-RSs) to enable a victim UE (e.g., UEs 1815a, 1815c) to measure the RSRP of the CLI-RSs to determine the CLI strength. The aggressor UE (e.g., UE 1815b) may also transmit a second set of CLI-RSs to enable the victim UE (e.g., UEs 1815a, 1815c) to measure an RSSI on the CLI-RSs. In some examples, the CLI-RSs may be existing reference signals (e.g., SRSs) that a victim UE (e.g., UEs 1815a, 1815c) measures to determine different metrics (e.g., RSRP and/or RSSI) of the CLI. The victim UE may measure the CLI strength (e.g., RSRP and/or RSSI) based on one or more of the received CLI-RSs from the aggressor UE. After the victim UE measures the CLI strength, the victim UE may report the measurements (e.g., RSRP and/or RSSI) of the CLI strength to the network (e.g., network entity 1840), for example, by transmitting the measurements to the network via a base station (e.g., base stations 1805a, 1805b) and a network link (e.g., links 1835a, 1835b). The network may then determine a phase compensation based on the received RSRP and/or RSSI measurements.

It should be noted that, generally, there may be multiple CLI SRS resources (e.g., CLI-RSs) used to identify different aggressor UEs. For example, one aggressor UE may be associated with one CLI SRS resource, and the aggressor UE may be identified by detecting the SRS. In CLI sensing, as previously mentioned, some of the CLI SRS resources may also configured for sensing purposes.

In one or more examples, during operation of the disclosed system 1800, the network (e.g., a network entity, such as network server 1840) may have knowledge regarding the phase continuity of a CLI sensing resource (e.g., SRS resource), and may indicate the phase continuity of the CLI sensing resource in a CLI sensing resource configuration to a victim UE (e.g., UEs 1815a, 1815c). Then, based on the CLI sensing resource configuration, the victim UE will have knowledge regarding the phase continuity of the CLI sensing resource.

For these examples, the CLI sensing configuration, which is configured by the network, may include one or more of the following first and second messages. The first message (e.g., including one (1) bit) may be used to indicate whether the CLI sensing resource has continuous phase or non-continuous phase, where a “1” bit may indicate that the phase is continuous and a “0” bit may indicate that the phase is not continuous. The second message (e.g., including N number of bits) may be used to indicate the available duration of the phase continuity (or non-continuity) of the CLI sensing resource (e.g., the number of bits may indicate how many SRS instances have continuous phase or not). For example, if the first message contains a “1” bit, and the second message contains “0001” bits, these two messages together indicate that the phase is continuous within one SRS instance of the CLI sensing resource (e.g., SRS resource). The following is example pseudocode for the indication by the network of the phase continuity in a CLI sensing resource configuration.

SRS Phase-Measurement-ResourceConfig-in CLI sensing

{... ..
Phase continuity indication, 1bit.
Phase continuity duration, N bits.
... ..}

The employment of an indication of the phase continuity in a CLI sensing resource configuration by a network assumes that the network has knowledge regarding whether the CLI sensing resource (e.g., SRS resource) is phase continuous or not. The network may obtain this knowledge from a variety of different sources. One of the sources of knowledge regarding whether the phase is continuous in the CLI sensing resource may be from historical information (e.g., from received CLI measurements previously obtained by other victim UEs). Another source of knowledge regarding whether the phase is continuous in the CLI sensing resource may be from received phase reports from aggressor UEs. Yet another source of knowledge regarding whether the phase is continuous in the CLI sensing resource may be from the self-implementation of the network itself. For example, during a long duration, the network may schedule an aggressor UE to only transmit in the CLI sensing resource and, as such, the aggressor UE may be able to keep the same PA state and maintain phase continuity.

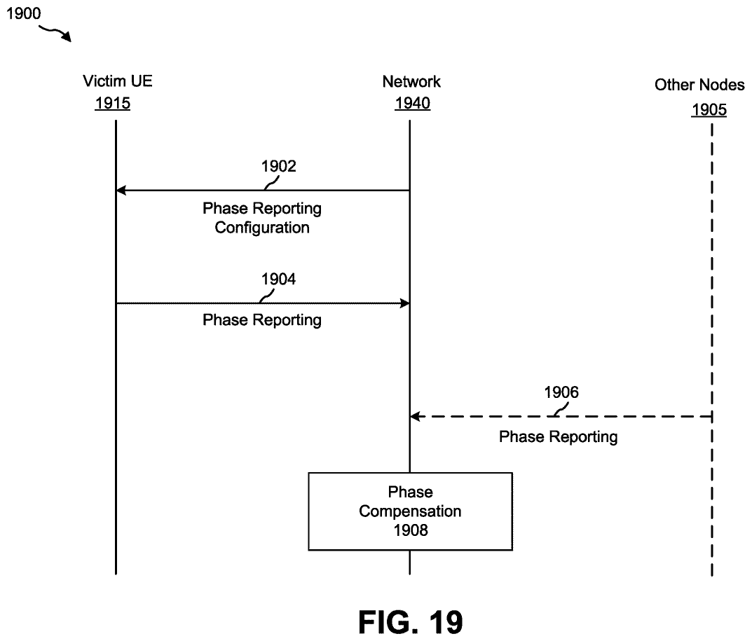

FIG. 19 is a diagram of an example communication exchange 1900 for phase reporting for the system 1800 of FIG. 18, in accordance with some examples. In particular, the communication exchange 1900 of FIG. 19 shows an example overall procedure for phase reporting that may be employed by the disclosed system 1800. It should be noted that all of the reporting actions shown in the communication exchange 1900 of FIG. 19 are configured for a victim UE 1915 (e.g., UEs 1815a, 1815c of FIG. 18).

In one or more examples, in CLI-based sensing, an SRS resource may be transmitted from an aggressor UE to a victim UE. However, it can be challenging for the aggressor UE to maintain and monitor the phase continuity between the bundled SRS sensing signals. For example, in the downlink, the aggressor UE may have to always switch between the different signals (different channels). The switching between the different signals may cause the aggressor UE to need to change its power level and PA state, which can lead to a change in the phase. In order to ensure that the phase is continuous within the SRS resource, the victim UE may measure and report the phase information of the configured SRS resource to the network. The network will then be able to use this received phase information to determine a phase compensation that may be used to correct for any discontinuities in the phase of the SRS resource.

In the communication exchange 1900 of FIG. 19, the network (e.g., network entity 1840 of FIG. 18) 1940 may configure the victim UE 1915 (and, optionally, by other nodes 1905) to perform phase reporting (e.g., phase continuity reporting) of the CLI sensing resource (e.g., SRS resource). The network 1940 may generate and transmit a phase reporting configuration (e.g., CLI sensing resource configuration) 1902 to the victim UE 1915 to configure the victim UE 1915 to perform phase reporting of the SRS resource. Then, after being configured to perform phase reporting, the victim UE 1915 (and, optionally, the other nodes 1905) may obtain SRS phase measurements of the SRS resource. The victim UE 1915 may then transmit a phase report 1904, which includes the SRS phase measurements, to the network 1940. Then, optionally, the other nodes may transmit phase reports 1906, which include the SRS phase measurements, to the network 1940. After the network 1940 receives the phase reports from the victim UE 1915 (and, optionally, from the other nodes 1905), the network 1940 may use the SRS phase measurements to determine (calculate) a phase compensation 1908 to be used to compensate for any phase discontinuities in the SRS resource to restore the phase continuity in the SRS resource.

In one or more examples, the network 1915 may indicate the phase reporting (e.g., phase continuity reporting) in the CLI sensing resource (e.g., SRS resource) by using one or of the following messages. A first message (e.g., including one (1) bit) may be used to indicate whether the phase is to be reported, where a “1” bit may indicate that the phase should be reported and a “0” bit may indicate that the phase should not be reported. A second message (e.g., including N number of bits) may be used to indicate the granularity of the reported phase quantization. In some cases, a third message (e.g., including M number of bits) may be used to indicate the report density. For example, bits may be mapped to certain predefined rules in the standard (e.g., phase reporting per SRS symbol or phase reporting when an event is triggered). The following is example pseudocode for the indication by the network 1915 of phase reporting (e.g., phase continuity reporting).

SRS Phase-Measurement-ResourceConfig-in CLI sensing

| {... .. | |
|---|---|
| Phase reporting, | bit 0 for non-reporting, bit 1 for |
| | phase reporting. |
| Phase value granularity, | N bits for the phase quantization. |
| Reporting density, | M bits mapped to the defined rules. |

... ..}

In one or more examples, the phase reporting configuration (e.g., CLI sensing resource configuration), which is generated by the network, may specifically indicate the content that should be included within the phase report (e.g., to be generated by the victim UE). For example, the phase reporting configuration may indicate that the phase report should include phase measurements obtained per SRS instance. The phase reporting configuration (e.g., CLI sensing resource configuration) may also indicate that the phase report should include the corresponding SRS occasion index for the phase measurements as well as an SRS resource(s) index for the phase measurements. In one or more examples, the SRS resource index may be mapped to the periodical SRS pattern with the dedicated sequence configuration (e.g., the SRS occasion).

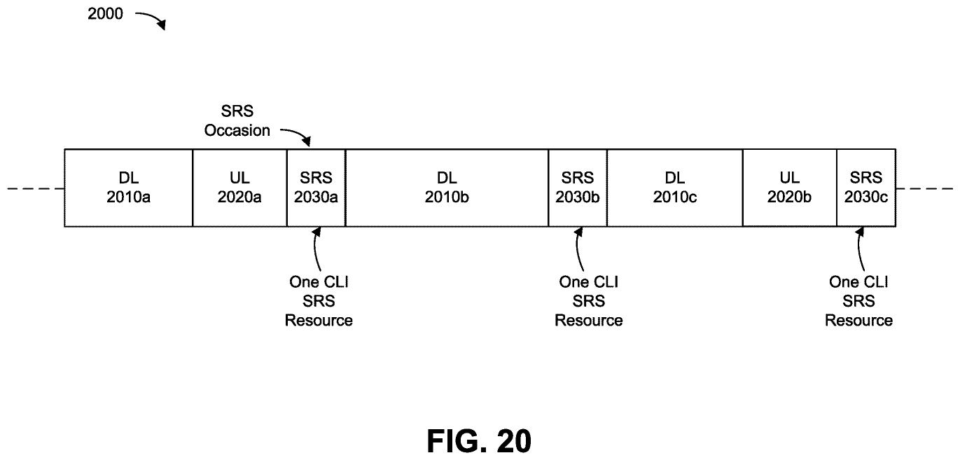

Example periodical SRS resources (e.g., SRS resources 2030a, 2030b, and 2030c) as well as an example SRS occasion (e.g., which comprises a block of the SRS resources 2030a, 2030b, and 2030c together) are illustrated in the frame structure 2000 of FIG. 20. In particular, FIG. 20 is a diagram illustrating an example frame structure 2000 with TDD multiplexing showing an SRS occasion, which may be employed by the disclosed systems and techniques for a phase continuity configuration in CLI-based sensing, in accordance with some examples. In FIG. 20, the frame structure 2000 may include a plurality of downlink (DL) communications resources 2010a, 2010b, 2010c, a plurality of uplink (UL) communications resources 2020a, 2020b, and a plurality of sensing (SRS) resources 2030a, 2030b, 2030c. In the frame structure 2000, the SRS resources 2030a, 2030b, and 2030c may each be considered to be a periodical resource. The block of the SRS resources 2030a, 2030b, and 2030c together may be considered to be an SRS occasion.

In one or more examples, for the phase reporting configuration (e.g., CLI sensing resource configuration), the SRS resource 2030a may be considered to be an SRS resource index, and the SRS resources 2030a, 2030b, and 2030c together may be considered to be an occasion index. The resource index (e.g., SRS resource 2030a) may be mapped to the SRS occasion index (e.g., including SRS resources 2030a, 2030b, and 2030c together) to indicate the start of the SRS occasion.

It should be noted that, in one or more examples, the phase reporting configuration (e.g., CLI sensing resource configuration) may indicate that the victim UE only needs to report phase continuity information (e.g., the victim UE does not need to report phase measurements, such as RSRP measurements). For example, in each CLI SRS phase report, the UE may only report phase continuity information (e.g., information regarding whether the phase is continuous or not) for the SRS resource.

The following is example pseudocode for the indication by the network of the content to be included within the phase reports for the phase reporting (e.g., phase continuity reporting).

CLI SRS Reporting Message

| {... .. | |
|---|---|
| RSRP value, | (has been defined in Release 16 CLI) |
| Phase continuity, | (1 bit) |

... ..}

In one or more examples, the phase reports may be reported using a periodical reporting pattern. Similar to CLI SRS RSRP reporting (which is defined in Release 16), the victim UE may send the measured phase (e.g., including phase continuity) of the SRS resource back to the network (e.g., which may be referred to as CLI SRS phase reporting).

In some examples, the CLI SRS phase reporting may be achieved by embedding the measured phase into the legacy CLI SRS RSRP reporting (defined in Release 16) to enable periodical CLI SRS phase reporting. For these examples, the corresponding measured phase of the SRS resource may be embedded within a CLI SRS RSRP reporting message for the measured RSRP of the SRS resource, following the legacy CLI SRS RSRP reporting pattern (defined in Release 16). The measured phase of the SRS resource may be included as a new additional element that is added within the legacy CLI SRS RSRP reporting message.

In other examples, a dedicated CLI SRS phase periodical reporting procedure may be defined. As previously mentioned, Release 16 has already defined the procedures for CLI RSSI and CLI SRS RSRP reporting. For these examples, the legacy CLI SRS RSRP reporting (defined in Release 16) is not leveraged, as in the previous embedding examples. As such, for these examples, a new procedure may be dedicatedly defined for CLI SRS phase periodical reporting. In addition, a specific reporting pattern may be defined to be used for the CLI SRS phase periodical reporting.

In one or more examples, the measured phase of the SRS resource may be reported within the phase reports for CLI SRS phase reporting by using a specific format. There are several different example formats that may be employed for the CLI SRS phase reporting of the measured phase value. For a first example format, layer 3 filtering (e.g., which is defined in Release 16 for CLI-RSRP measurements and reporting) may be used to report the measured phase, which may be based on multiple SRS measurements. The same procedures defined in Release 16 for the CLI-RSRP measurements and reporting may be employed for the phase measurements and reporting of the SRS resource. It should be noted that employing an L3 measurement saves the SRS resource, and overcomes the impact of random noise.

For a second example format, one specific measured phase of an SRS resource obtained within the configured phase measurement duration (e.g., the last measured phase taken within the phase measurement duration) is reported within the phase reports for CLI SRS phase reporting. This second example format may be considered to be a low density reporting because it requires that only one phase measurement, obtained within a phase measurement duration, be reported.

For a third example format, all of the measured phases of the SRS resources obtained within the configured phase measurement duration (e.g., all of the measured phases taken within the phase measurement duration) are reported within the phase reports for CLI SRS phase reporting. This third example format may be considered to be a high density reporting because it requires that all phase measurements, obtained within a phase measurement duration, be reported.

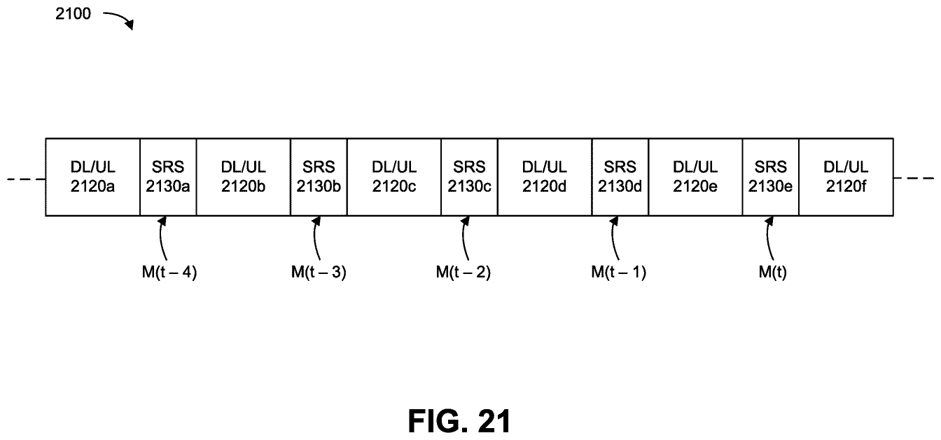

For a fourth example format, the reporting of the measured phases of the SRS resources depends upon the time that each of the measured phases were taken within the configured phase measurement duration. The example frame structure 2100 of FIG. 21 shows SRS resources 2130a-2130e located at different times within a phase measurement duration. In particular, FIG. 21 is a diagram illustrating an example frame structure 2100 with TDD multiplexing showing a phase measurement duration, which may be employed by the disclosed systems and techniques for a phase continuity configuration in CLI-based sensing, in accordance with some examples. In FIG. 21, the frame structure 2100 may include a plurality of downlink/uplink (DL/UL) communications resources 2120a, 2120b, 2120c, 2120d, 2120e, and 2120f (collectively referred to as communications resources 2120a-2120f), and a plurality of sensing (SRS) resources 2130a, 2130b, 2130c, 2130d, and 2130e (collectively referred to as SRS resources 2130a-2130e). The phase measurement duration for the SRS resources of the frame structure 2100 spans from time (t−4) to time t, where phase measurements are taken at times (t−4), (t−3), (t−2), (t−1), and t.

There are several different example options that may be employed for the fourth example format. For a first example option, the measured phases of the SRS resources are reported according to an output of a filter, which is represented as P(t). In one or more examples, P(t) may be equal to (1−a)P(t−1)+aM(t), where a is a parameter of the filter and M(t) is a measurement taken of the physical layer at time t. For this first example option, only the output of the filter P(t) may be reported within the phase reports for CLI SRS phase reporting. For a second example option, only M(t) (e.g., a phase measurement taken at time t) may be reported within the phase reports for CLI SRS phase reporting. For a third example option, all of the phase measurements taken during the phase measurement duration (e.g., M(t−4), M(t−3), M(t−2), M(t−1), and M(t)) may be reported within the phase reports for CLI SRS phase reporting.

As such, for the fourth example format, the reporting of the measured phases of the SRS resources within the phase reports for CLI SRS phase reporting for the three example options may be summarized as follows.
Option 1: {P(t)}, P(t)=(1−a)P(t−1)+aM(t)
Option 2: {M(t)}
Option 3: {M(t−4), M(t−3), M(t−2), M(t−1), M(t)}

The determination of which example format to be used by the disclosed system 1800 may be based upon the application of the sensing because different sensing uses cases require different specific phase variation patterns. For example, for vital sign breathing monitoring of a user (e.g., users 1002a, and 1002b of FIG. 10), since the phase variation is slow and the phase variation in one duration is limited, the first example format using layer 3 measurements may be employed to accurately track the phase value.

Conversely, for vital sign heartbeat monitoring of a user, since the phase variation is fast (e.g., the phase variation is largely changed within adjacent SRS measurements), the use of L3 measurements will not allow for an accurate tracking of the phase value. As such, the third example format, where all of the measured phases taken within the phase measurement duration are reported, may be employed for vital sign heartbeat monitoring.

It should be noted that, in one or more examples, the network may indicate the specific format (e.g., the first example format, the second example format, the third example format, or the fourth example format) to be employed for the CLI SRS phase reporting of the measured phase value. In some examples, the network may indicate that the lowest density of the reporting pattern for the measured phase should be used for the CLI SRS phase reporting of the measured phase value. In other examples, the network may indicate that the highest density of the reporting pattern for the measured phase should be used for the CLI SRS phase reporting of the measured phase value.

In one or more examples, an event may trigger the CLI SRS phase reporting. For these examples, a phase variation threshold may be defined. The measured phase will only be reported, when the phase variation of the phase measurements becomes larger than the defined phase variation threshold. As such, the exceeding of the phase variation threshold triggers the CLI SRS phase reporting. In some examples, the network may define the phase variation threshold. In at least one example, the phase variation threshold may be defined to be located between a most recent (in time) measurement taken and a buffered oldest (in time) phase measurement.

In one or more examples, the phase reports for CLI SRS phase reporting may include various different phase measurement information. In one example, the phase reports may include the current measured phase (e.g., measured at time t), the corresponding phase variation (e.g., measured between times t and (t−1)), and an SRS resource index. In another example, the phase reports may include the last phase measurement (e.g., measured at time (t−1)) and the corresponding phase variation (e.g., measured between times t and (t−1)).

In at least one example, the phase reports may only include an SRS occasion index, when the phase measurement is larger than the phase variation threshold. For example, if the phase variation threshold is defined to be equal to π/2, and the current phase measurement is equal to |φ(t)−φ(t−1)|, which is greater than π/2; then the current SRS occasion index is reported. The SRS occasion index will indicate to the network where the phase discontinuity (phase jumping) is occurring within the phase measurement duration.

As an application example, referring back to FIG. 18, during operation of the disclosed system (e.g., system 1800 of FIG. 18), an aggressor UE (e.g., UE 1815b) may transmit 1810b or 1810c an SRS resource for CLI (e.g., CLI-RS), which a victim UE (e.g., UE 1815a or UE 1815c) may receive 1810a or 1810d. The victim UE (e.g., UE 1815a or 1815c) may be configured to transmit a phase report (e.g., which may include phase continuity information) of the SRS resource to the network. For example, a victim UE (e.g., UE 1815a) may transmit a phase report of the SRS resource to the network entity (e.g., network server) 1840 via base station 1805a, signal 1825a, and network link 1835a. After the network receives the phase report, the network may leverage the phase report as historical knowledge. Based on the information within the phase report, the network will have knowledge of whether or not the SRS resource has phase continuity. Then network may then directly transmit a signal 1825c to indicate the phase continuity of the SRS resource to another nearby victim UE (e.g., UE 1815c).

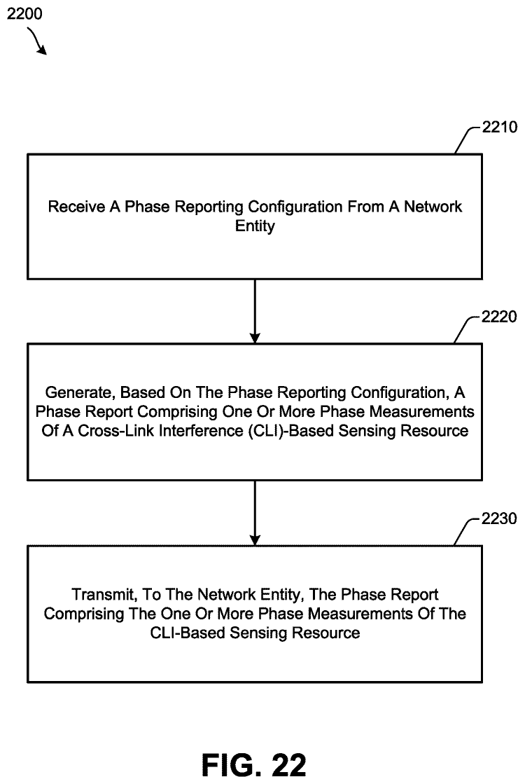

FIG. 22 is a flow chart illustrating an example of a process 2200 for wireless communications, such as to provide a phase continuity configuration in CLI-based sensing. The process 2200 can be performed by a computing device or apparatus, such as a wireless communications device (e.g., a UE) or a component or system (e.g., a chipset) of the wireless communication device. The operations of the process 2200 may be implemented as software components that are executed and run on one or more processors of the computing device (e.g., controller/processor 280 of the UE 104 of FIG. 1, processor (2) 684 of the electronic device computing system 670 of FIG. 6, processor 722 of the wireless device 700, and/or other processor(s)). Further, the transmission and reception of signals by the computing device in the process 2200 may be enabled, for example, by one or more antennas (e.g., antennas 252a through 252r of FIG. 2, antenna 687 of FIG. 6, antenna 712 and/or antenna 714 of FIG. 7, and/or other antenna(s)) and/or one or more transceivers (e.g., one or more of the TX MIMO processor 266 and DEMODs/MODs 254a through 254r of FIG. 2, wireless transceiver(s) 678 of FIG. 6, and/or other transceivers or transceiver components).

At block 2210, the computing device may receive a phase reporting configuration from a network entity. The network entity may be a network server, a base station, or a portion (e.g., a CU, a DU, a RU, a Near-RT RIC, or a Non-RT RIC) of a base station having a disaggregated architecture. In some aspects, the phase reporting configuration may include information indicating whether the CLI-based sensing resource has phase continuity, information indicating a duration of the phase continuity, an indication to report the phase report to the network entity, information indicating a granularity of a reported phase quantization for the phase report, information indicating a reporting density for the phase report, an indication of one or more formats for obtaining the one or more phase measurements of the CLI-based sensing resource, any combination thereof, and/or other information.

At block 2220, the computing device may generate, based on the phase reporting configuration, a phase report comprising one or more phase measurements of a cross-link interference (CLI)-based sensing resource. In one illustrative example, the CLI-based sensing resource is a sounding reference signal (SRS) resource, such as shown in FIG. 20. In other examples, the CLI-based sensing resource may be a positioning reference signal (PRS) resource, a demodulation reference signal (DMRS) resource, a channel-state information (CSI) reference signal (CSI-RS) resource, a phase tracking reference signal (PTRS) resource, a communication resource, and/or other type of resource. In some aspects, the phase report includes phase measurement results per sensing resource of a plurality of CLI-based sensing resources. In some cases, the phase report includes one or more corresponding indices for each sensing resource of the plurality of CLI-based sensing resources. For instance, one or more indices for a sensing resource from the plurality of CLI-based sensing resources may include an occasion index, a resource index, or both.

At block 2230, the computing device may transmit, to the network entity, the phase report comprising the one or more phase measurements of the CLI-based sensing resource. In some cases, the one or more phase measurements are transmitted to the network entity for determining a phase compensation for the CLI-based sensing resource to restore phase continuity of the CLI-based sensing resource. For instance, the network entity may determine, based on the one or more phase measurements, the phase compensation for the CLI-based sensing resource to restore phase continuity of the CLI-based sensing resource. In some aspects, the computing device may obtain (e.g., receive, measure, etc.) the one or more phase measurements of the CLI-based sensing resource. In some cases, the one or more phase measurements of the CLI-based sensing resource comprise an indication of phase continuity.

In some aspects, the computing device may transmit the phase report to the network entity based on an event. In one illustrative example, the event is based on a phase variation of the one or more phase measurements of the CLI-based sensing resource exceeding a phase variation threshold.

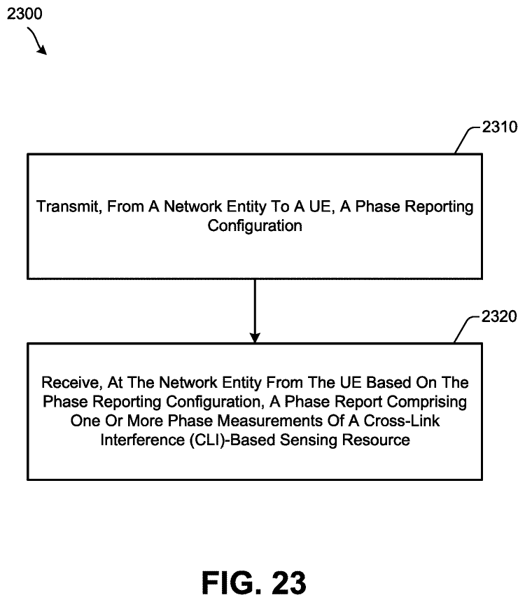

FIG. 23 is a flow chart illustrating an example of a process 2300 for wireless communications such as to provide a phase continuity configuration in CLI-based sensing. The process 2300 can be performed by a network entity (e.g., an eNB, a gNB, a location server such as an LMF) or a portion of the network entity (e.g., a chipset or one or more of a CU, a DU, a RU, a Near-RT RIC, or a Non-RT RIC). The operations of the process 2300 may be implemented as software components that are executed and run on one or more processors of the network entity (e.g., controller/processor 240 of the base station 102 of FIG. 2 and/or other processor(s)). Further, the transmission and reception of signals by the network entity in the process 2300 may be enabled, for example, by one or more antennas (e.g., antennas 234a through 234t FIG. 2, and/or other antenna(s)) and/or one or more transceivers (e.g., one or more of the TX MIMO processor 230 or the MODs/DEMODs 232a through 232t of FIG. 2, and/or other transceivers or transceiver components).

At block 2310, the network entity may transmit, to a UE, a phase reporting configuration. In some aspects, the phase reporting configuration may include information indicating whether the CLI-based sensing resource has phase continuity, information indicating a duration of the phase continuity, an indication to report the phase report to the network entity, information indicating a granularity of a reported phase quantization for the phase report, information indicating a reporting density for the phase report, an indication of one or more formats for obtaining the one or more phase measurements of the CLI-based sensing resource, any combination thereof, and/or other information.

At block 2320, the network entity may receive, from the UE based on the phase reporting configuration, a phase report comprising one or more phase measurements of a cross-link interference (CLI)-based sensing resource. In one illustrative example, the CLI-based sensing resource is a sounding reference signal (SRS) resource, such as shown in FIG. 20. In other examples, the CLI-based sensing resource may be a positioning reference signal (PRS) resource, a demodulation reference signal (DMRS) resource, a channel-state information (CSI) reference signal (CSI-RS) resource, a phase tracking reference signal (PTRS) resource, a communication resource, and/or other type of resource. In some cases, the one or more phase measurements of the CLI-based sensing resource comprise an indication of phase continuity. In some aspects, the phase report includes phase measurement results per sensing resource of a plurality of CLI-based sensing resources. In some cases, the phase report includes one or more corresponding indices for each sensing resource of the plurality of CLI-based sensing resources. For instance, one or more indices for a sensing resource from the plurality of CLI-based sensing resources may include an occasion index, a resource index, or both.

In some aspects, the network entity may determine, based on the one or more phase measurements, a phase compensation for the CLI-based sensing resource to restore phase continuity of the CLI-based sensing resource.

In some aspects, the network entity may receive the phase report from the UE based on an event. In one illustrative example, the event is based on a phase variation of the one or more phase measurements of the CLI-based sensing resource exceeding a phase variation threshold.

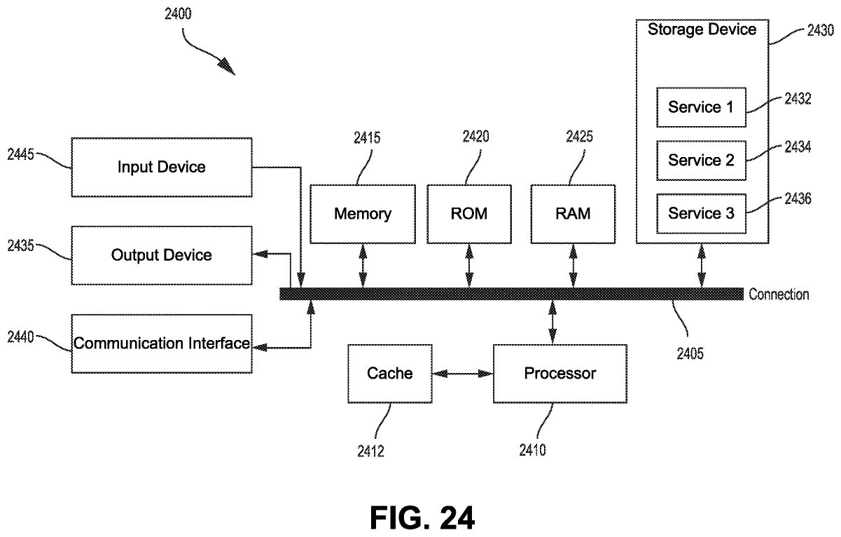

FIG. 24 is a block diagram illustrating an example of a computing system 2400 that may be employed by the disclosed system for a phase continuity configuration in CLI-based sensing, in accordance with some examples. In particular, FIG. 24 illustrates an example of computing system 2400, which can be for example any computing device making up internal computing system, a remote computing system, a camera, or any component thereof in which the components of the system are in communication with each other using connection 2405. Connection 2405 can be a physical connection using a bus, or a direct connection into processor 2410, such as in a chipset architecture. Connection 2405 can also be a virtual connection, networked connection, or logical connection.

In some embodiments, computing system 2400 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 2400 includes at least one processing unit (CPU or processor) 2410 and connection 2405 that communicatively couples various system components including system memory 2415, such as read-only memory (ROM) 2420 and random access memory (RAM) 2425 to processor 2410. Computing system 2400 can include a cache 2412 of high-speed memory connected directly with, in close proximity to, or integrated as part of processor 2410.

Processor 2410 can include any general purpose processor and a hardware service or software service, such as services 2432, 2434, and 2436 stored in storage device 2430, configured to control processor 2410 as well as a special-purpose processor where software instructions are incorporated into the actual processor design. Processor 2410 may essentially be a completely self-contained computing system, containing multiple cores or processors, a bus, memory controller, cache, etc. A multi-core processor may be symmetric or asymmetric.

To enable user interaction, computing system 2400 includes an input device 2445, which can represent any number of input mechanisms, such as a microphone for speech, a touch-sensitive screen for gesture or graphical input, keyboard, mouse, motion input, speech, etc. Computing system 2400 can also include output device 2435, which can be one or more of a number of output mechanisms. In some instances, multimodal systems can enable a user to provide multiple types of input/output to communicate with computing system 2400.

Computing system 2400 can include communications interface 2440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 2440 may also include one or more range sensors (e.g., LIDAR sensors, laser range finders, RF radars, ultrasonic sensors, and infrared (IR) sensors) configured to collect data and provide measurements to processor 2410, whereby processor 2410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 2440 may also include one or more Global Navigation Satellite System (GNSS) receivers or transceivers that are used to determine a location of the computing system 2400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2430) can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2430 can include software services, servers, services, etc., that when the code that defines such software is executed by the processor 2410, it causes the system to perform a function. In some embodiments, a hardware service that performs a particular function can include the software component stored in a computer-readable medium in connection with the necessary hardware components, such as processor 2410, connection 2405, output device 2435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more DSPs, general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative aspects of the disclosure include:

Aspect 1. A method for wireless communications at a user equipment (UE), the method comprising: receiving, at the UE, a phase reporting configuration from a network entity; generating, at the UE based on the phase reporting configuration, a phase report comprising one or more phase measurements of a cross-link interference (CLI)-based sensing resource; and transmitting, to the network entity, the phase report comprising the one or more phase measurements of the CLI-based sensing resource.

Aspect 2. The method of Aspect 1, wherein the one or more phase measurements are transmitted to the network entity for determining a phase compensation for the CLI-based sensing resource to restore phase continuity of the CLI-based sensing resource.

Aspect 3. The method of any of Aspects 1 to 2, wherein the phase reporting configuration comprises information indicating whether the CLI-based sensing resource has phase continuity.

Aspect 4. The method of Aspect 3, wherein the phase reporting configuration further comprises information indicating a duration of the phase continuity.

Aspect 5. The method of any of Aspects 1 to 4, wherein the phase reporting configuration comprises an indication to report the phase report to the network entity.

Aspect 6. The method of any of Aspects 1 to 5, wherein the phase reporting configuration comprises information indicating a granularity of a reported phase quantization for the phase report.

Aspect 7. The method of any of Aspects 1 to 6, wherein the phase reporting configuration comprises information indicating a reporting density for the phase report.

Aspect 8. The method of any of Aspects 1 to 7, wherein the phase reporting configuration comprises an indication of one or more formats for obtaining the one or more phase measurements of the CLI-based sensing resource.

Aspect 9. The method of any of Aspects 1 to 8, further comprising: obtaining, at the UE, the one or more phase measurements of the CLI-based sensing resource.

Aspect 10. The method of any of Aspects 1 to 9, wherein the CLI-based sensing resource is a sounding reference signal (SRS) resource.

Aspect 11. The method of any of Aspects 1 to 10, wherein the one or more phase measurements of the CLI-based sensing resource comprise an indication of phase continuity.

Aspect 12. The method of any of Aspects 1 to 11, further comprising transmitting the phase report to the network entity based on an event.

Aspect 13. The method of Aspect 12, wherein the event is based on a phase variation of the one or more phase measurements of the CLI-based sensing resource exceeding a phase variation threshold.

Aspect 14. The method of any of Aspects 1 to 13, wherein the phase report comprises phase measurement results per sensing resource of a plurality of CLI-based sensing resources.

Aspect 15. The method of Aspect 14, wherein the phase report comprises one or more corresponding indices for each sensing resource of the plurality of CLI-based sensing resources.

Aspect 16. The method of Aspect 15, wherein one or more indices for a sensing resource from the plurality of CLI-based sensing resources includes at least one of an occasion index or a resource index.

Aspect 17. The method of any of Aspects 1 to 16, wherein the network entity is a network server, a base station, or a portion of a base station having a disaggregated architecture.

Aspect 18. An apparatus for wireless communications, comprising: a memory; and one or more processors coupled to the memory, the one or more processors configured to: receive a phase reporting configuration from a network entity, generate, based on the phase report configuration, a phase report comprising one or more phase measurements of a cross-link interference (CLI)-based sensing resource, and transmit, to the network entity, the phase report comprising the one or more phase measurements of the CLI-based sensing resource.

Aspect 19. The apparatus of Aspect 18, wherein the one or more phase measurements are transmitted to the network entity for determining a phase compensation for the CLI-based sensing resource to restore phase continuity of the CLI-based sensing resource.

Aspect 20. The apparatus of any of Aspects 18 to 19, wherein the phase reporting configuration comprises information indicating whether the CLI-based sensing resource has phase continuity.

Aspect 21. The apparatus of Aspect 20, wherein the phase reporting configuration comprises information indicating a duration of the phase continuity.

Aspect 22. The apparatus of any of Aspects 18 to 21, wherein the phase reporting configuration comprises an indication to report the phase report to the network entity.

Aspect 23. The apparatus of any of Aspects 18 to 22, wherein the phase reporting configuration comprises information indicating a granularity of a reported phase quantization for the phase report.

Aspect 24. The apparatus of any of Aspects 18 to 23, wherein the phase reporting configuration comprises information indicating a reporting density for the phase report.

Aspect 25. The apparatus of any of Aspects 18 to 24, wherein the phase reporting configuration comprises an indication of one or more formats for obtaining the one or more phase measurements of the CLI-based sensing resource.

Aspect 26. The apparatus of any of Aspects 18 to 25, wherein the one or more processors are configured to: obtain the one or more phase measurements of the CLI-based sensing resource.

Aspect 27. The apparatus of any of Aspects 18 to 26, wherein the CLI-based sensing resource is a sounding reference signal (SRS) resource.

Aspect 28. The apparatus of any of Aspects 18 to 27, wherein the one or more phase measurements of the CLI-based sensing resource comprise an indication of phase continuity.

Aspect 29. The apparatus of any of Aspects 18 to 28, wherein the one or more processors are configured to: transmit the phase report to the network entity based on an event.

Aspect 30. The apparatus of Aspect 29, wherein the event is based on a phase variation of the one or more phase measurements of the CLI-based sensing resource exceeding a phase variation threshold.

Aspect 31. The apparatus of any of Aspects 18 to 30, wherein the phase report comprises phase measurement results per sensing resource of a plurality of CLI-based sensing resources.

Aspect 32. The apparatus of Aspect 31, wherein the phase report comprises one or more corresponding indices for each sensing resource of the plurality of CLI-based sensing resources.

Aspect 33. The apparatus of Aspect 32, wherein one or more indices for a sensing resource from the plurality of CLI-based sensing resources includes at least one of an occasion index or a resource index.

Aspect 34. The apparatus of any of Aspects 18 to 33, wherein the network entity is a network server, a base station, or a portion of a base station having a disaggregated architecture.

Aspect 35. The apparatus of any of Aspects 18 to 34, wherein the apparatus is configured as a user equipment (UE), and further comprising: a transceiver configured to receive the phase reporting configuration and transmit the phase report.

Aspect 36. A method for wireless communications at a network entity, the method comprising: transmitting, to a UE, a phase reporting configuration; and receiving, at the network entity from the UE based on the phase reporting configuration, a phase report comprising one or more phase measurements of a cross-link interference (CLI)-based sensing resource.

Aspect 37. The method of Aspect 36, further comprising determining, based on the one or more phase measurements, a phase compensation for the CLI-based sensing resource to restore phase continuity of the CLI-based sensing resource.

Aspect 38. The method of any of Aspects 36 to 37, wherein the phase reporting configuration comprises information indicating whether the CLI-based sensing resource has phase continuity.

Aspect 39. The method of Aspect 38, wherein the phase reporting configuration further comprises information indicating a duration of the phase continuity.

Aspect 40. The method of any of Aspects 36 to 39, wherein the phase reporting configuration comprises an indication to report the phase report to the network entity.

Aspect 41. The method of any of Aspects 36 to 40, wherein the phase reporting configuration comprises information indicating a granularity of a reported phase quantization for the phase report.

Aspect 42. The method of any of Aspects 36 to 41, wherein the phase reporting configuration comprises information indicating a reporting density for the phase report.

Aspect 43. The method of any of Aspects 36 to 42, wherein the phase reporting configuration comprises an indication of one or more formats for obtaining the one or more phase measurements of the CLI-based sensing resource.

Aspect 44. The method of any of Aspects 36 to 43, wherein the CLI-based sensing resource is a sounding reference signal (SRS) resource.

Aspect 45. The method of any of Aspects 36 to 44, wherein the one or more phase measurements of the CLI-based sensing resource comprise an indication of phase continuity.

Aspect 46. The method of any of Aspects 36 to 45, further comprising receiving the phase report from the UE based on an event.

Aspect 47. The method of Aspect 46, wherein the event is based on a phase variation of the one or more phase measurements of the CLI-based sensing resource exceeding a phase variation threshold.

Aspect 48. The method of any of Aspects 36 to 47, wherein the phase report comprises phase measurement results per sensing resource of a plurality of CLI-based sensing resources.

Aspect 49. The method of Aspect 48, wherein the phase report comprises one or more corresponding indices for each sensing resource of the plurality of CLI-based sensing resources.

Aspect 50. The method of Aspect 49, wherein one or more indices for a sensing resource from the plurality of CLI-based sensing resources includes at least one of an occasion index or a resource index.

Aspect 51. The method of any of Aspects 36 to 50, wherein the network entity is a network server, a base station, or a portion of a base station having a disaggregated architecture.

Aspect 52. An apparatus for wireless communications, comprising: a memory; and one or more processors coupled to the memory, the one or more processors configured to: transmit, to a UE, a phase reporting configuration; and receive, from the UE based on the phase reporting configuration, a phase report comprising one or more phase measurements of a cross-link interference (CLI)-based sensing resource.

Aspect 53. The apparatus of Aspect 52, wherein the one or more processors are configured to: determine, based on the one or more phase measurements, a phase compensation for the CLI-based sensing resource to restore phase continuity of the CLI-based sensing resource.

Aspect 54. The apparatus of any of Aspects 52 to 53, wherein the phase reporting configuration comprises information indicating whether the CLI-based sensing resource has phase continuity.

Aspect 55. The apparatus of Aspect 54, wherein the phase reporting configuration further comprises information indicating a duration of the phase continuity.

Aspect 56. The apparatus of any of Aspects 52 to 55, wherein the phase reporting configuration comprises an indication to report the phase report to the network entity.

Aspect 57. The apparatus of any of Aspects 52 to 56, wherein the phase reporting configuration comprises information indicating a granularity of a reported phase quantization for the phase report.

Aspect 58. The apparatus of any of Aspects 52 to 57, wherein the phase reporting configuration comprises information indicating a reporting density for the phase report.

Aspect 59. The apparatus of any of Aspects 52 to 58, wherein the phase reporting configuration comprises an indication of one or more formats for obtaining the one or more phase measurements of the CLI-based sensing resource.

Aspect 60. The apparatus of any of Aspects 52 to 59, wherein the CLI-based sensing resource is a sounding reference signal (SRS) resource.

Aspect 61. The apparatus of any of Aspects 52 to 60, wherein the one or more phase measurements of the CLI-based sensing resource comprise an indication of phase continuity.

Aspect 62. The apparatus of any of Aspects 52 to 61, wherein the one or more processors are configured to receive the phase report from the UE based on an event.

Aspect 63. The apparatus of Aspect 62, wherein the event is based on a phase variation of the one or more phase measurements of the CLI-based sensing resource exceeding a phase variation threshold.

Aspect 64. The apparatus of any of Aspects 52 to 63, wherein the phase report comprises phase measurement results per sensing resource of a plurality of CLI-based sensing resources.

Aspect 65. The apparatus of Aspect 64, wherein the phase report comprises one or more corresponding indices for each sensing resource of the plurality of CLI-based sensing resources.

Aspect 66. The apparatus of Aspect 65, wherein one or more indices for a sensing resource from the plurality of CLI-based sensing resources includes at least one of an occasion index or a resource index.

Aspect 67. The apparatus of any of Aspects 52 to 66, wherein the apparatus is configured as a network entity, and further comprising: a transceiver configured to transmit the phase reporting configuration and receive the phase report.

Aspect 68. The apparatus of Aspect 67, wherein the network entity is a network server, a base station, or a portion of a base station having a disaggregated architecture.

What is claimed is:

1. A method for wireless communications at a user equipment (UE), the method comprising:
receiving, at the UE, a phase reporting configuration from a network entity;
generating, at the UE based on the phase reporting configuration, a phase report comprising one or more phase measurements of a cross-link interference (CLI)-based sensing resource; and
transmitting, to the network entity, the phase report comprising the one or more phase measurements of the CLI-based sensing resource.

2. The method of claim 1, wherein the one or more phase measurements are transmitted to the network entity for determining a phase compensation for the CLI-based sensing resource to restore phase continuity of the CLI-based sensing resource.

3. The method of claim 1, wherein the phase reporting configuration comprises at least one of information indicating whether the CLI-based sensing resource has phase continuity or information indicating a duration of the phase continuity.

4. The method of claim 1, wherein the phase reporting configuration comprises an indication to report the phase report to the network entity.

5. The method of claim 1, wherein the phase reporting configuration comprises at least one of information indicating a granularity of a reported phase quantization for the phase report or information indicating a reporting density for the phase report.

6. The method of claim 1, wherein the phase reporting configuration comprises an indication of one or more formats for obtaining the one or more phase measurements of the CLI-based sensing resource.

7. The method of claim 1, further comprising:
obtaining, at the UE, the one or more phase measurements of the CLI-based sensing resource.

8. The method of claim 1, wherein the CLI-based sensing resource is a sounding reference signal (SRS) resource.

9. The method of claim 1, wherein the one or more phase measurements of the CLI-based sensing resource comprise an indication of phase continuity.

10. The method of claim 1, further comprising transmitting the phase report to the network entity based on an event.

11. The method of claim 10, wherein the event is based on a phase variation of the one or more phase measurements of the CLI-based sensing resource exceeding a phase variation threshold.

12. The method of claim 1, wherein the phase report comprises phase measurement results per sensing resource of a plurality of CLI-based sensing resources.

13. The method of claim 12, wherein the phase report comprises one or more corresponding indices for each sensing resource of the plurality of CLI-based sensing resources.

14. The method of claim 13, wherein one or more indices for a sensing resource from the plurality of CLI-based sensing resources includes at least one of an occasion index or a resource index.

15. The method of claim 1, wherein the network entity is a network server, a base station, or a portion of a base station having a disaggregated architecture.

16. An apparatus for wireless communications, comprising:
a memory; and
one or more processors coupled to the memory, the one or more processors configured to:
receive a phase reporting configuration from a network entity,
generate, based on the phase report configuration, a phase report comprising one or more phase measurements of a cross-link interference (CLI)-based sensing resource, and
transmit, to the network entity, the phase report comprising the one or more phase measurements of the CLI-based sensing resource.

17. The apparatus of claim 16, wherein the one or more phase measurements are transmitted to the network entity for determining a phase compensation for the CLI-based sensing resource to restore phase continuity of the CLI-based sensing resource.

18. The apparatus of claim 16, wherein the phase reporting configuration comprises at least one of information indicating whether the CLI-based sensing resource has phase continuity, information indicating a duration of the phase continuity, an indication to report the phase report to the network entity, information indicating at least one of a granularity of a reported phase quantization for the phase report or information indicating a reporting density for the phase report, or an indication of one or more formats for obtaining the one or more phase measurements of the CLI-based sensing resource.

19. The apparatus of claim 16, wherein the one or more processors are configured to:
obtain the one or more phase measurements of the CLI-based sensing resource.

20. The apparatus of claim 16, wherein the CLI-based sensing resource is a sounding reference signal (SRS) resource.

21. The apparatus of claim 16, wherein the one or more phase measurements of the CLI-based sensing resource comprise an indication of phase continuity.

22. The apparatus of claim 16, wherein the one or more processors are configured to: transmit the phase report to the network entity based on an event.

23. The apparatus of claim 22, wherein the event is based on a phase variation of the one or more phase measurements of the CLI-based sensing resource exceeding a phase variation threshold.

24. The apparatus of claim 16, wherein the phase report comprises phase measurement results per sensing resource of a plurality of CLI-based sensing resources.

25. The apparatus of claim 16, wherein the network entity is a network server, a base station, or a portion of a base station having a disaggregated architecture.

26. The apparatus of claim 16, wherein the apparatus is configured as a user equipment (UE), and further comprising:
a transceiver configured to receive the phase reporting configuration and transmit the phase report.

27. A method for wireless communications at a network entity, the method comprising:
transmitting, to a UE, a phase reporting configuration; and
receiving, at the network entity from the UE based on the phase reporting configuration, a phase report comprising one or more phase measurements of a cross-link interference (CLI)-based sensing resource.

28. An apparatus for wireless communications, comprising:
a memory; and
one or more processors coupled to the memory, the one or more processors configured to:
transmit, to a UE, a phase reporting configuration; and
receive, from the UE based on the phase reporting configuration, a phase report comprising one or more phase measurements of a cross-link interference (CLI)-based sensing resource.

29. The apparatus of claim 28, wherein the apparatus is configured as a network entity, and further comprising:
a transceiver configured to transmit the phase reporting configuration and receive the phase report.

30. The apparatus of claim 29, wherein the network entity is a network server, a base station, or a portion of a base station having a disaggregated architecture.
